(19) United States
(12) Patent Application Publication
(10) Pub. No.: US 2026/0038835 A1
(43) Pub. Date: Feb. 5, 2026

(54) CONDUCTIVE COATINGS AND METHODS OF MAKING THE SAME

(71) Applicant: Donaldson Company, Inc., Bloomington, MN (US)

(72) Inventors: Madeline C. Peterson, Minneapolis, MN (US); Patricia A. Ignacio-de Leon, Minnetonka, MN (US); Yehya A. Elsayed, Bloomington, MN (US)

(21) Appl. No.: 19/285,729

(22) Filed: Jul. 30, 2025

Related U.S. Application Data
(60) Provisional application No. 63/678,354, filed on Aug. 1, 2024.

(51) Int. Cl. H01M 4/62; H01M 4/02; H01M 4/04

(52) U.S. Cl. CPC H01M 4/62; H01M 4/0428; H01M 2004/021

(57) ABSTRACT

Coated electrode active materials, coated electrode assemblies, and electrochemical cells containing the same. Coated electrode active materials include an electrode active material and a coating disposed on a surface of the electrode active material. Coated electrode assemblies include an electrode assembly and a coating disposed on a surface of the electrode assembly.

### CROSS-REFERENCE TO RELATED APPLICATION

This application claims the benefit of U.S. Provisional Patent Application No. 63/678,354, filed Aug. 1, 2024, which is incorporated herein by reference in its entirety.

### INTRODUCTION

Batteries, or electrochemical cells, are ubiquitous in society providing power to everything from flashlights to vehicles. The lifetime of a battery can be shortened due to adverse reactions between the electrolyte and one or both electrodes. For example, the electrolyte can react with electrode active materials of an electrode resulting in dissolution of the electrode active materials into the electrolyte and/or conversion of electrode active materials into non-electrochemically active materials. Techniques and materials for elongating battery lifetime are needed.

### SUMMARY

The present disclosure describes coated electrode active material. A coated electrode active material includes an electrode active material and a continuous, conformal coating disposed on a surface of the electrode active material. In some embodiments, the coating may have a thickness of 100 nm or less as measured via the Thickness Test Method. In some embodiments, the coating may have an electronic conductivity of 1 S/m or greater as measured according to the Electronic Conductivity Test Method. The coating includes a polymer. The polymer may be electrically conductive, ionically conductive, or both. In some embodiments, the polymer may be plasma polymerized.

In some embodiments, the coated electrode active material is formed by a method that includes polymerizing and depositing the polymer of the coating onto the electrode active surface using plasma enhanced chemical vapor deposition. In some embodiments, polymerizing and depositing the polymer of the coating includes exposing a pre-plasma mixture to plasma forming conditions, the pre-plasma mixture including a monomer to be polymerized and a carrier gas. In some embodiments, the pre-plasma mixture includes a process gas. In some embodiments, the process gas includes oxygen.

The present disclosure further describes coated electrode assemblies. A coated electrode assembly includes an electrode assembly and a continuous, conformal coating disposed on a surface of the electrode assembly. The electrode assembly includes an electrode composite and a current collector. The electrode composite includes electrode active material, a binder, and an additive. In some embodiments, the coating may have a thickness of 100 nm or less as measured via the Thickness Test Method. In some embodiments, the coating may have an electronic conductivity of 1 S/m or greater as measured according to the Electronic Conductivity Test Method. The coating includes a polymer. The polymer may be electrically conductive, ionically conductive, or both. In some embodiments, the polymer may be plasma polymerized.

In some embodiments, the coated electrode assembly is formed by a method that includes polymerizing and depositing the polymer of the coating onto the electrode assembly surface using plasma enhanced chemical vapor deposition. In some embodiments, polymerizing and depositing the polymer of the coating includes exposing a pre-plasma mixture to plasma forming conditions, the pre-plasma mixture comprising a monomer to be polymerized and a carrier gas. In some embodiments, the pre-plasma mixture includes a second gas. In some embodiments, the process gas includes oxygen.

In some embodiments, the polymer of the coating is polymerized from a hydrocarbon monomer comprising an aromatic group; an acyclic hydrocarbon monomer; a heteroaromatic monomer; a heteroaryl monomer; a mixed heteroatom containing monomer; or any combination thereof. In some embodiments, the hydrocarbon monomer including an aromatic group is fluorene, phenylene, pyrene, azulene, naphthalene, or styrene. In some embodiments, the acyclic hydrocarbon monomer is acetylene. In some embodiments, the heteroaromatic monomer is pyrrole, carbazole, indole, azepine, or thiophene. In some embodiments, the heteroaryl monomer is phenol, aniline, or phenyl sulfide. In some embodiments, the mixed heteroatom containing monomer is 3,4-ethylenedioxythiophenc.

In some embodiments, the polymer of the coating comprises poly(fluorene), poly(phenylene), poly(pyrene), poly(azulene), poly(naphthalene), poly(styrene), any combination thereof, or any oxidized derivative thereof. In some embodiments, the polymer comprises poly(acetylene) or an oxidized derivative thereof. In some embodiments, the polymer comprises poly(pyrrole), poly(carbazole), poly(indole), poly(azepine), poly(thiophene), any combination thereof, or any oxidized derivative thereof. In some embodiments, the polymer comprises poly(phenol), poly(aniline), poly(phenyl sulfide), any combination thereof, or any oxidized derivative thereof.

The present disclosure further describes electrochemical cells. The electrochemical cell includes a positive electrode assembly, a negative electrode assembly, a separator, and an electrolyte. At least one of the positive electrode assembly and the negative electrode assembly includes the electrode assembly containing the coated electrode active material of the present disclosure or the coated electrode active material of the present disclosure.

### BRIEF DESCRIPTION OF DRAWINGS

FIG. 1 is a cross-sectional side view of a coated bulk material consistent with embodiments of the present disclosure.

FIG. 2 is a cross-sectional side view of an electrode assembly consistent with embodiments of the present disclosure.

FIG. 3 is a cross-sectional side view of a coated electrode assembly consistent with embodiments of the present disclosure.

FIG. 4 is a flow diagram of a method for making a coated bulk material (e.g., a coated electrode active material or coated electrode assembly) consistent with embodiments of the present disclosure.

FIG. 5 is a cross-sectional side view of an electrochemical cell consistent with embodiments of the present disclosure.

FIG. 6 is an overlay of Fourier transformed infrared spectra of an 3,4-ethylenedioxythiophene (EDOT) monomer, a commercially available poly(3,4-ethylenedioxythiophene) (PEDOT) complex coating, and two PEDOT coatings formed using two different plasma enhanced chemical vapor deposition (PECVD) conditions.

FIG. 7 is an optical microscopy image of a PEDOT coating deposited using PECVD under partial oxygen atmosphere conditions.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

In the description, particular embodiments may be described in isolation for clarity. Reference throughout this specification to “one embodiment,” “an embodiment,” “certain embodiments,” “one or more embodiments,” or “some embodiments,” etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. Thus, features described in the context of one embodiment may be combined with features described in the context of a different embodiment except where the features are necessarily mutually exclusive.

For any method disclosed herein that includes discrete steps, the steps may be performed in any feasible order. And, as appropriate, any combination of two or more steps may be performed simultaneously.

### DETAILED DESCRIPTION

Batteries typically include a positive electrode, a negative electrode, an electrolyte, and a separator. Battery lifetime and performance can be impacted by deleterious reactions between electrode active materials within the electrodes and the electrolyte. The positive electrode (cathode) and negative electrode (anode) of a battery directly interact with the electrolyte. The electrolyte can react with the electrode active materials of the electrodes directly exposed to the electrolyte. For example, in lithium-ion batteries, reactions of the electrolyte with the electrode can result in dissolution of the electrode active material from the electrode into the electrolyte. Lithium ions can be consumed through the formation of inactive and nonconductive species thereby decreasing the concentration of active lithium in the battery. The inactive and nonconductive lithium containing species can be deposited on an electrode surface creating barriers for ion and electron transport. Additionally, in some cases, the electrolyte can break down into species that are more easily vaporized which may, in turn, result in pressure build-up and swelling or bulging of the battery package.

The present application describes coated surfaces useful for inclusion in electrochemical cells. In some embodiments, the coated surface is of an electrode active material. As such, the present application describes coated electrode active materials. In some embodiments, the coated surface is of an electrode assembly. As such, the present application describes coated electrode assemblies. The coatings may be electronically conductive. The coatings may be ionically conductive. The coatings may be electronically conductive and ionically conductive.

The present application discloses coated electrode active materials, electrodes containing the same, coated electrode assemblies, and electrochemical cells containing the coated electrode active materials and/or the coated electrode assemblies. When included in an electrochemical cell, the coated electrode active material and/or the coated electrode assembly may increase the electrochemical cell lifetime and/or performance compared to an electrochemical cell having the same electrode active material or electrode assembly but lacking the coating. For example, an electrochemical cell including a coated electrode active material and/or coated electrode assembly of the present disclosure may have an increased specific capacity retention and/or function over more charge-discharge cycles as compared to a battery having the same electrode active material but lacking the coating or the same electrode assembly but lacking the coating.

Without wishing to be bound by theory, it is thought that the coatings of the present disclosure may act as a protective barrier for the electrode active material and/or the electrode assembly. The coatings may, for example, prevent or reduce the rate of electrode active material dissolution into the electrolyte. The coatings may prevent or reduce the rate of inactive species formation from active ions (e.g., lithium ions). The coatings may prevent or reduce the rate of electrolyte decomposition.

### Coatings for Coated Electrode Active Material and Coated Electrode Assemblies

The present disclosure describes coated materials that may be useful for inclusion in an electrochemical cell. The coatings are disposed on one or more surfaces. The one or more surfaces may be of an electrode active material, an electrode assembly, or both.

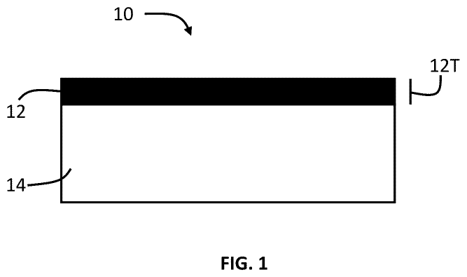

FIG. 1 is a cross-sectional side view of a coated bulk material. The coated bulk material includes a bulk material 14 and a coating 12 disposed on at least a portion of at least one surface of the bulk material 14. In some embodiments, the bulk material 14 is an electrode active material. In other embodiments, the bulk material 14 is an electrode assembly. The bulk material 14 may be of any form factor. For example, the bulk material 14 may be planar or non-planar. As such, the coating 12 may be planar or nonplanar. In some embodiments, the coating 12 may be disposed on multiple surfaces of the bulk material 14. For example, in some embodiments, the coating 12 may be disposed on the bulk material 14 such that the coating 12 forms a shell surrounding a bulk material 14 core.

The coating disposed on the surface of an electrode active material or electrode assembly may be electrically conductive, ionically conductive, or both. A coating that is electrically conductive and ionically conductive may allow for ion and electron transport between portions of electrode active material and the electrolyte.

The coating includes a polymer. The polymer may be electrically conductive, ionically conductive, or both. Polymers are polymerized from one or more monomers. A polymer polymerized from a particular monomer may be described as “monomer name” polymer or poly(monomer name). For example, a polymer polymerized from pyrrole monomers, may be described as a pyrrole polymer or poly(pyrrole). A polymer formed from or polymerized from a monomer may include other components that may not be expressly described relative to the polymer that is formed from or polymerized from the stated components. For example, a polymer formed from or polymerized from one or more monomers may include capping groups or other groups not expressly mentioned. Additionally, a polymer polymerized from one or more monomers may include atoms not present in the monomer or monomers used to form the polymer. For example, in some embodiments when the polymer is polymerized via plasma polymerization (e.g., via plasma enhanced chemical vapor deposition) in a plasma atmosphere formed from at least oxygen gas, the resultant polymer may be oxidized and/or include oxygen atoms not present in the monomers used to form the polymer. As such, unless expressly stated, it is understood that a plasma polymerized polymer includes both the unoxidized and oxidized polymers.

In some embodiments, the polymer is polymerized from a monomer that includes one or more aromatic groups. As such, the polymer may be poly(aromatic). The one or more aromatic groups can be substituted at any position with any suitable chemical moiety. An example of a substituted poly(aromatic) polymer is poly(3,4-ethylenedioxythiophene) and oxidized derivatives thereof.

In some embodiments, the polymer is polymerized from a hydrocarbon monomer. A hydrocarbon monomer has only carbon and hydrogen atoms. The hydrocarbon monomer may be an acyclic monomer, a cyclic hydrocarbon monomer, or include both an acyclic portion and a cyclic portion.

In some embodiments, the polymer is polymerized from a cyclic hydrocarbon monomer. The cyclic hydrocarbon monomer may be aromatic or include an aromatic group. In some embodiments, the cyclic hydrocarbon may be polycyclic. In some embodiments, the polycyclic hydrocarbon may include two or more aromatic rings. Examples of hydrocarbon monomers that are aromatic or include an aromatic group include fluorene, phenyl, pyrene, azulene, naphthalene, biphenyl, anthracene, phenanthrene, phenalene, tetracene, chrysene, triphenylene, pentacene, perylene, benzo[a]pyrene, corannulene, benzo[ghi]perylene, coronene, ovalene, and benzo[c]fluorene. In some embodiments, the polymer is poly(fluorene), poly(phenylene), poly(pyrene), poly(azulene), poly(naphthalene), poly(styrene), a hydrocarbon substituted derivative thereof, an oxidized derivatives thereof, or any combination thereof.

In some embodiments, the polymer is polymerized from an acyclic hydrocarbon monomer. An example of an acyclic hydrocarbon monomer is acetylene. In some embodiments, the polymer is poly(acetylene) or an oxidized derivative thereof.

In some embodiments, the polymer is polymerized from hydrocarbon monomer having a cyclic portion and an acyclic portion. Examples of such monomers include styrene and para-xylylene. In some embodiments, the polymer is poly(styrene) or an oxidized derivative thereof. In some embodiments, the polymer is poly(parylene) or an oxidized derivative thereof. Poly(parylene) can be polymerized from para-xylene monomers or other monomers.

In some embodiments, the polymer is polymerized from a heteroatom containing monomer that also includes an aromatic group. The heteroatom may be, for example, nitrogen, oxygen, sulfur, or any combination thereof. The heteroatom may be a part of an aromatic group. In embodiments where a heteroatom is a part of the aromatic group, the monomer is a heteroaromatic monomer. The heteroatom may be external to the aromatic group. In embodiments, where the heteroatom is external, but directly bonded to, an aromatic group, the monomer is an heteroaryl monomer. In some embodiments where there are two or more heteroatoms, at least one heteroatom can be a part of the aromatic group and at least one heteroatom can be external to the aromatic group. In embodiments where the monomer includes one or more heteroatoms apart of the aromatic group and one or more heteroatoms external to the aromatic group, the monomer is a mixed heteroatom containing monomer.

In some embodiments, the polymer is polymerized from a heteroaromatic monomer. In some embodiments, the heteroatom is a nitrogen. In some embodiments, the heteroatom is sulfur. In some embodiments, the heteroatom is oxygen. The heteroaromatic monomer may be polycyclic. Examples of heteroaromatic monomer include, pyrrole, carbazole, indole, azepine, thiophene, pyridine, substituted derivatives thereof, or any combination thereof. In some embodiments, the polymer is poly(pyrrole), poly(carbazole), poly(indole), poly(azepine), a substituted derivative thereof, an oxidized derivative thereof, or any combination thereof. In some embodiments, the heteroaromatic monomer include two or more heteroatoms. Examples of heteroaromatic monomers that include two or more heteroatoms include, dibenzofuran, acridine, thiepine, azecine, and the like.

In some embodiments, the polymer is polymerized from a heteroaryl monomer. In some embodiments, the heteroatom is a nitrogen. In some embodiments, the heteroatom is sulfur. In some embodiments, the heteroatom is oxygen. Examples of heteroaryl monomers include phenol, aniline, and phenyl sulfide. In some embodiments, the polymer is a poly(aniline), a poly(phenyl sulfide), a substituted derivative thereof, an oxidized derivative thereof, or any combination thereof.

In some embodiments, the polymer is polymerized from a mixed heteroatom containing monomer. An example of a mixed heteroatom containing monomer is 3,4-ethylenedioxythiophene. In some embodiments, the polymer poly(3,4-ethylenedioxythiophene) (PEDOT) or an oxidized derivative thereof. PEDOT is a substituted derivative of poly(thiophenc).

In some embodiments, the polymer is polymerized from two or more monomers. As such, the polymer may be copolymerized from two or more monomers. The additional monomer may or may not form an electronically and/or ionically conductive polymer when homopolymerized. However, when an additional monomer is copolymerized with a monomer described herein, the resultant polymer may be electrically and/or ionically conductive. Examples of additional monomers include poly(tetrahedral silsesquioxanes), hydroboranes, and borane clusters. The polymer may be formed by copolymerization of a silseqquioxane, a hydroborane, or a borane cluster with another monomer described herein to form an electronically and/or ionically conductive polymer.

The polymer may be polymerized and deposited onto the surface (e.g., an electrode active material and/or an electrode assembly) using chemical vapor deposition (CVD). In CVD monomer undergo polymerization in the vapor phase and/or once deposited onto a surface. There are many sub-types of CVD that can be used to polymerize the polymer of the coating and deposition the coating onto the electrode active material or the electrode assembly. For example, in some embodiments, the polymer may be polymerized and deposited on the electrode active material or electrode assembly using plasma enhance chemical vapor deposition (PECVD). In PECVD, the polymer is plasma polymerized.

In some embodiments, plasma chemical vapor deposition may be used polymerization and deposition of the polymer onto the electrode active material or electrode assembly. Examples of plasma chemical vapor deposition include microwave plasma-assisted chemical vapor deposition, plasma-enhanced chemical vapor deposition, remote plasma-enhanced chemical vapor depiction, and low-energy plasma enhanced chemical vapor deposition. In some embodiments, the polymer is formed (e.g., polymerized) and deposited using plasma-enhanced chemical vapor deposition (PECVD).

In PECVD, polymers are formed through plasma polymerization. Stated differently, the polymer may be plasma polymerized. As such, in some embodiments, the polymer is plasma polymerized via PECVD. Plasma polymerization, such as via PECVD, includes the use of plasma to affect polymerization. Monomers are exposed to plasma and/or an electromagnetic field used to generate the plasma, which activates the monomer. For example, activation of a monomer by plasma and/or an applied electromagnetic field can include monomer radical formation, monomer ionization, monomer fragmentation, or any combination thereof. Once activated, the monomers can react with each other and/or any other compound. For example, if monomers have access to a surface during plasma polymerization (e.g., during PECVD), the activated monomers can react with each other and/or interact with the surface to form a polymer on the surface (be deposited on the surface). As such, if a surface is present during plasma polymerization, polymerization may occur while the monomers are in the gas phase and/or at the surface-plasma interface.

The composition of gases used to form the plasma in PECVD can impact the composition of the polymer. For example, atoms of gases used to form the plasma may be incorporated into the polymer. As such, a polymer may include atoms that were not present in the monomers used to form the polymer. For example, a polymer polymerized in a plasma atmosphere from oxygen may include oxygen atoms not present in the monomer used to form the polymer. For instance, a mixed nitrogen and oxygen atmosphere can allow for the formation of reactive oxygen species that may react with other species in the chamber to create a more oxidized polymer. As such, a polymer formed by plasma polymerization may be an oxidized polymer, also called an oxidized derivative of a polymer.

Plasma polymerization results in polymers having distinct structures and characteristics. Plasma polymerized polymers have irregular network-like structures lacking extensive discrete repeat units. For example, the plasma polymerization process promotes extensive branching and crosslinking.

Returning to FIG. 1, the coating 12 disposed on a surface of the bulk material 14 has an average coating thickness 12T. Average coating thickness can be measured, for example, using optical profilometry according to the Average Thickness Test Method (see Test Methods in the Examples). The average coating thickness can vary, for example, from 0.01 nanometers (nm) to 50 nm as measured according to the Thickness Test Method. Generally, thinner coatings are desirable. For example, given a fixed total volume or mass of coated bulk material (e.g., electrode active material or electrode assembly), a thinner coating allows a larger proportion of the fixed total volume or mass to be the bulk material.

In some embodiments, the average coating thickness is 0.01 nm or greater, 0.1 nm or greater, 0.2 nm or greater, 0.3 nm or greater, 0.4 nm or greater, 0.5 nm or greater, 0.6 nm or greater, 0.7 nm or greater, 0.8 nm or greater, 0.9 nm or greater, 1 nm or greater, 2 nm or greater, 3 nm or greater, 4 nm or greater, 5 nm or greater, 6 nm or greater, 7 nm or greater, 8 nm or greater, 9 nm or greater, 10 nm or greater, 20 nm or greater, 30 nm or greater, 40 nm or greater, 50 nm or greater, or 60 nm or greater as measured according to the Average Thickness Test Method. In some embodiments, the average coating thickness is 75 nm or less, 70 nm or less, 60 nm or less, 50 nm or less, 40 nm or less, 30 nm or less, 20 nm or less, 10 nm or less, 9 nm or less, 8 nm or less, 7 nm or less, 6 nm or less, 5 nm or less, 4 nm or less, 3 nm or less, 2 nm or less, 1 nm or less, 0.9 nm or less, 0.8 nm or less, 0.7 nm or less, 0.6 nm or less, 0.5 nm or less, 0.4 nm or less, 0.3 nm or less, 0.2 nm or less, or 0.1 nm or less as measured according to the Average Thickness Test Method.

In some embodiments, the average coating thickness is 75 nm or less, for example, 50 nm or less as measured according to the Average Thickness Test Method. In some embodiments, the average coating thickness is 0.01 nm to 75 nm, 0.01 nm to 50 nm, 0.1 nm to 75 nm, 0.1 nm to 50 nm, 1 nm to 75 nm, 1 nm to 50 nm, 10 nm to 75 nm, or 10 nm to 50 nm.

In some embodiments, the average coating thickness is 10 nm or less, for example, 5 nm or less as measured according to the Average Thickness Test Method. In some embodiments, the average coating thickness is 1 nm to 5 nm, 2 nm to 5 nm, 3 nm to 5 nm, 4 nm to 5 nm, 1 nm to 4 nm, 2 nm to 4 nm, 2 nm to 3 nm, or 2 nm to 3 nm as measured according to the Average Thickness Test Method.

In some embodiments, the average coating thickness is 1 nm or less as measured according to the Average Thickness Test Method. For example, in some embodiments, the average coating thickness is 0.01 nm to 1 nm, such as, 0.01 nm to 0.9 nm, 0.01 nm to 0.8 nm, 0.01 nm to 0.7 nm, 0.01 nm to 0.6 nm, 0.01 nm to 0.5 nm, 0.01 nm to 0.4 nm, 0.01 to 0.3 nm, 0.01 nm to 0.2 nm, or 0.01 nm to 0.1 nm as measured according to the Average Thickness Test Method. In some embodiments the average coating thickness is 0.1 nm to 1 nm, 0.1 nm to 0.9 nm, 0.1 nm to 0.8 nm, 0.1 nm to 0.7 nm, 0.1 nm to 0.6 nm, 0.1 nm to 0.5 nm, 0.1 nm to 0.4 nm, 0.1 nm to 0.3 nm, or 0.1 nm to 0.2 nm as measured according to the Average Thickness Test Method. In some embodiments, the average coating thickness is 0.2 nm to 1 nm, 0.2 nm to 0.9 nm, 0.2 nm to 0.8 nm, 0.2 nm to 0.7 nm, 0.2 nm to 0.6 nm, 0.2 nm to 0.5 nm, 0.2 nm to 0.4 nm, or 0.2 nm to 0.3 nm as measured according to the Average Thickness Test Method. In some embodiments, the average coating thickness is 0.3 nm to 1 nm, 0.3 nm to 0.9 nm, 0.3 nm to 0.8 nm, 0.3 nm to 0.7 nm, 0.3 nm to 0.6 nm, 0.3 nm to 0.5 nm, or 0.3 nm to 0.4 nm as measured according to the Average Thickness Test Method. In some embodiments, the average coating thickness is 0.4 nm to 1 nm, 0.4 nm to 0.9 nm, 0.4 nm to 0.8 nm, 0.4 nm to 0.7 nm, 0.4 nm to 0.6 nm, or 0.4 nm to 0.5 nm as measured according to the Average Thickness Test Method. In some embodiments the average coating thickness is 0.5 nm to 1 nm, 0.5 nm to 0.9 nm, 0.5 nm to 0.8 nm, 0.5 nm to 0.7 nm, or 0.5 nm to 0.6 nm as measured according to the Average Thickness Test Method. In some embodiments the average coating thickness is 0.6 nm to 1 nm, 0.6 nm to 0.9 nm, 0.6 nm to 0.8 nm, or 0.6 nm to 0.7 nm as measured according to the Average Thickness Test Method. In some embodiments the average coating thickness is 0.7 nm to 1 nm, 0.7 nm to 0.9 nm, 0.7 nm to 0.8 nm, 0.8 nm to 1 nm, 0.8 nm to 0.9 nm, or 0.9 nm to 1 nm as measured according to the Average Thickness Test Method.

The coating may be uniform. For example, the variability in the thickness of the coating may be minimal. The variability in the thickness of the coating may be determined according to the Thickness Variability Test Method (see Test Methods in the Examples). In some embodiments, the variability in the coating thickness is within 20%, 10%, 5%, 2.5%, or 1% of the average coating thickness as determined according to the Thickness Variability Test Method. In some embodiments, the variability in the coating thickness is within 20% of the average coating thickness as determined according to the Thickness Variability Test Method. In some embodiments, the variability in the coating thickness is within 10% of the average coating thickness as determined according to the Thickness Variability Test Method. In some embodiments, the variability in the coating thickness is within 5% of the average coating thickness as determined according to the Thickness Variability Test Method. In some embodiments, the variability in the coating thickness is within 2.5% of the average coating thickness as determined according to the Thickness Variability Test Method. In some embodiments, the variability in the coating thickness is within 1% of the average coating thickness as determined according to the Thickness Variability Test Method.

The electronic conductivity of the coating may vary. Electronic conductivity is a measure of a material's ability to conduct electricity. Electronic conductivity of the coating can be measured, for example, using sheet resistance measured by the four-point probe method according to the Electronic Conductivity Test Method (see Test Methods in the Examples).

In some embodiments, the electronic conductivity of the coating may be 0.001 Siemens(S) per meter (m) (S/m) to 10 S/m as measured according to the Electronic Conductivity Test Method. In some embodiments, the coating has an electronic conductivity of 0.001 S/m or greater, 0.01 S/m or greater, 0.1 S/m or greater, 0.2 S/m or greater, 0.3 S/m or greater, 0.4 S/m or greater, 0.5 S/m or greater, 0.6 S/m or greater, 0.7 S/m or greater, 0.8 S/m or greater, 0.9 S/m or greater, 1 S/m or greater, 1.1 S/m or greater, 1.2 S/m or greater, 1.3 S/m or greater, 1.4 S/m or greater, 1.6 S/m or greater, 1.7 S/m or greater, 1.8 S/m or greater, 1.9 S/m or greater, 2 S/m or greater, 3 S/m or greater, 4 S/m or greater, or 5 S/m or greater as measured according to the Electronic Conductivity Test Method. In some embodiments, the coating has an electronic conductivity of 10 S/m or less, 5 S/m or less, 4 S/m or less, 3 S/m or less, 2 S/m or less, 1.9 S/m or less, 1.8 S/m or less, 1.7 S/m or less, 1.6 S/m or less, 1.5 S/m or less, 1.4 S/m or less, 1.3 S/m or less, 1.2 S/m or less, 1.1 S/m or less, 1 S/m or less, 0.9 S/m or less, 0.8 S/m or less, 0.7 S/m or less, 0.6 S/m or less, 0.5 S/m or less, 0.4 S/m or less, 0.3 S/m or less, 0.2 S/m or less, 0.1 S/m or less, or 0.01 S/m or less as measured according to the Electronic Conductivity Test Method.

In some embodiments, the coating has an electronic conductivity of 0.1 S/m to 10 S/m. For example, in some embodiments the coating has an electronic conductivity of 0.1 S/m to 10 S/m, 0.1 S/m to 5 S/m, 0.1 S/m to 4 S/m, 0.1 S/m to 3 S/m, 0.1 S/m to 2 S/m 0.1 S/m to 1 S/m as measured according to the Electronic Conductivity Test Method. In some embodiments, the coating has an electronic conductivity of 0.2 S/m to 10 S/m, 0.2 S/m to 5 S/m, 0.2 S/m to 4 S/m, 0.2 S/m to 3 S/m, 0.2 S/m to 2 S/m, or 0.2 S/m to 1 S/m as measured according to the Electronic Conductivity Test Method. In some embodiments, the coating has an electronic conductivity of 0.5 S/m to 10 S/m, 0.5 S/m to 5 S/m, 0.5 S/m to 4 S/m, 0.5 S/m to 3 S/m, 0.5 S/m to 2 S/m, or 0.5 S/m to 1 S/m as measured according to the Electronic Conductivity Test Method. In some embodiments, the coating has an electronic conductivity of 0.7 S/m to 10 S/m, 0.7 S/m to 5 S/m, 0.7 S/m to 4 S/m, 0.7 S/m to 3 S/m, 0.7 S/m to 2 S/m, or 0.7 S/m to 1 S/m as measured according to the Electronic Conductivity Test Method.

In some embodiments, the coating has an electronic conductivity of 1 S/m to 10 S/m. For example, in some embodiments the coating has an electronic conductivity of 1 S/m to 10 S/m, 1 S/m to 5 S/m, 1 S/m to 4 S/m, 1 S/m to 3 S/m, or 1 S/m to 2 S/m as measured according to the Electronic Conductivity Test Method. In some embodiments, the coating has an electronic conductivity of 1.2 S/m to 10 S/m, 1.2 S/m to 5 S/m, 1.2 S/m to 4 S/m, 1.2 S/m to 3 S/m, or 1.2 S/m to 2 S/m as measured according to the Electronic Conductivity Test Method. In some embodiments, the coating has an electronic conductivity of 1.5 S/m to 10 S/m, 1.5 S/m to 5 S/m, 1.5 S/m to 4 S/m, 1.5 S/m to 3 S/m, or 1.5 S/m to 2 S/m as measured according to the Electronic Conductivity Test Method. In some embodiments, the coating has an electronic conductivity of 1.7 S/m to 10 S/m, 1.7 S/m to 5 S/m, 1.7 S/m to 4 S/m, 1.7 S/m to 3 S/m, or 1.7 S/m to 2 S/m as measured according to the Electronic Conductivity Test Method.

The coating may be continuous or highly continuous on the surface of the electrode active material or electrode assembly. For example, the percent surface coverage of the coating on the electrode active material or an electrode assembly may be high. Percent surface coverage can be measured, for example, according to the Surface Coverage Test Method (see the Test Methods in the Examples). In some embodiments, the percent surface coverage is 80% or greater, 90% or greater, 95% or greater, or 99% or greater.

### Coated Electrode Active Material

In some embodiments, the coating is applied to an electrode active material. Stated differently, the present disclosure describes coated electrode active materials. For example, in some embodiments, the bulk material 14 of FIG. 1 is an electrode active material. The electrode active material may be of any form factor. For example, the electrode active material may be planar or non-planar. The coating may be any coating described herein having any characteristic or property described herein.

The electrode active material may be any suitable electrode active material. In some embodiments, the electrode active material is a positive electrode (cathode) active material. In some embodiments, the electrode active material includes lithium. In some embodiments, the positive electrode active material includes lithium and one or more metals. Examples of positive electrode active materials include lithium cobalt oxide; lithium iron phosphate; lithium manganese oxide; lithium nickel cobalt aluminum oxide (NCA), and lithium nickel oxide. Additional examples include lithium nickel manganese cobalt oxides (NMC) and lithium manganese oxides. NMCs may be of the formula of LₓNi_{y}Mn_{z}Co_{1-y-z}O₂ (0<x,y,z<1). Examples of NMCs include LiNi_{0.33}Mn_{0.33}Co_{0.33}O₂ (NMC333 or NMC111); LiNi_{0.5}Mn_{0.3}Co_{0.2}O₂ (NMC532); LiNi_{0.6}Mn_{0.2}Co_{0.2}O₂ (NMC622); LiNi_{0.8}Mn_{0.1}Co_{0.1}O₂ (NMC811); and any combinations thereof. Examples of lithium manganese oxides include LiMn₂O₄; Li₂MnO₃; LiMnO₂; Li₂MnO₂; and any combinations thereof. The positive electrode active material may be in the form of a disordered rocksalt. The positive electrode active material may be doped, for example, with molybdenum, vanadium, titanium, or other elements.

In embodiment, the electrode active material is a negative electrode (anode) active material. Examples of negative electrode active material include graphite, silicon-graphite mixtures, lithium titanium oxide, transition metal chalcogenides (e.g., molybdenum sulfide), transition metal carbides, transition metal oxides, transition metal phosphides, binary transition metal oxides, aluminum niobates, titanium niobates, and any combinations thereof. Examples of negative electrode active materials include cobalt oxides (e.g., Co₃O₄), copper oxides (e.g., Cu₂O), lithium titanate (Li₄Ti₅O₁₂), silicon oxides (e.g., SiO₂), iron oxides (e.g., Fe₂O₃), nickel aluminide (e.g., Al₃Ni), copper cobalt oxides (e.g., CuCo₂O₄), lead nickel bismuth alloys (e.g., PdNiBi), titanium oxides (e.g., TiO), tin phosphorus alloys (e.g., Sn₄P₃), nickel oxides (e.g., NiO), carbides thereof, and any combinations thereof. Examples of metallic negative electrode active material include lithium metal and alkaline earth metals such as magnesium or calcium, as well as silicon-based compounds. The silicon-based compounds may be in the form of Si fibers. Further examples of negative electrode active materials include lithium aluminum alloys, lithium silicon alloys, lithium bismuth alloys, lithium cadmium alloys, aluminum magnesium alloys, lithium magnesium alloys, lithium tin alloys, lithium antimony alloys, iron tin alloys, tin antimony alloys, tin copper alloys, lithium germanium alloys, lithium lead alloys, oxides thereof, sulfides thereof, phosphides thereof, carbides thereof, nitrides thereof, and any combinations thereof. The molecular formula of an negative electrode active compound species may not reflect the empirical formula. Additional examples of negative electrode active materials include nitrides, oxides, carbides, of metallic or semi-metallic elements including Li, Co, Pd, Pt, W, Mo, Zr, Fe, Al, Ni, Ti, Sn, and any combination thereof.

Electrode Assemblies that Include Coated Electrode Active Material

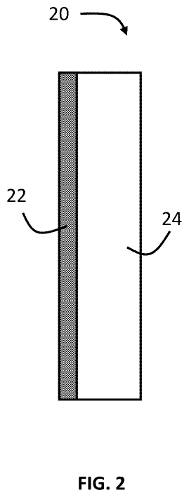

The present disclosure further describes electrode assemblies that include a coated electrode active material as described herein. A cross-section side view of an illustrative electrode assembly 20 is shown in FIG. 2. The electrode assembly 20 includes a current collector 22 and an electrode composite 24. The current collector 20 is electrically coupled to the electrode composite 24. At least one surface of the current collector 20 may be contacting at least one surface of the electrode composite 24.

The electrode assembly may be a positive (cathode) electrode assembly or a negative (anode) electrode assembly. The identity (e.g., positive or negative) of the electrode assembly depends at least in part on the identity of the electrode active material or the coated electrode active material. In some embodiments, the electrode assembly is a positive electrode. In some embodiments, the electrode assembly is a negative electrode.

The electrode assembly 20 includes electrode composite 24. Electrode composite 24 can include a coated electrode active material (e.g., a coated positive electrode active material or a coated negative electrode active material) of the present disclosure. Electrode composite 24 can include an uncoated electrode active material. The electrode composite 24 may further include a binder, one or more additives, or both.

In some embodiments, the electrode 20 assembly and/or the electrode composite 24 includes a binder. The binder allows for the physical connection and/or electrical connection of two or more parts of the electrode (e.g., current collector, coated electrode active material, and any present additives). Any binder may be used. Examples of suitable binders include carboxy methyl cellulose (CMC), styrene-butadiene rubber (SBR), poly(vinylidene fluoride) (PVDF), poly(tetrafluoroethylene) (PTFE), poly(acrylic acid), or combinations thereof. In certain embodiments, the binder includes PVDF.

In some embodiments, the electrode composite 24 includes one or more additives. An additive may be an electrically conductive additive. Electrically conductive additives may serve to enhance the electrochemical performance of the electrode assembly. Any suitable electrically conductive material may be included as an electrically conductive additive. Examples of suitable conductive materials include, but are not limited to, carbon powder, carbon fiber, graphite, carbon nanotubes, graphene, graphyne, bronze, copper, tungsten, carbon steel, silver, gold, aluminum, zinc, INCONEL (available from American Special Metals, Corp. in Miami, FL), HASTELLOY (available from Hastelloy International Corporation in Tipton, IN), KOVAR (available from CRS Holdings Inc in Oklahoma City, OK), or any combinations thereof. In some embodiments, the electrode composite 24 includes a carbon electrically conductive additive.

The electrode assembly 20 includes a current collector 22. Any suitable current collector may be used. Current collectors collect the electrical current generated within an electrochemical cell and external circuits to which the electrochemical cell is coupled. A current collector may include any suitable material or combination of materials. Suitable current collector materials may be selected based on porosity, electrical conductivity, or material compatibility with the electrode composite, as a few examples. Suitable current collector materials may include, for example, nickel, copper, aluminum, titanium, or stainless steel. Other examples of suitable current collector materials may include alloys, such as aluminum alloys or titanium alloys. The current collector may be at least partially porous. Porous current collectors may be useful, for example, to permit the electrolyte to penetrate the current collector. For example, the current collector may be in the form of a mesh or grid, which may be useful, for example, to permit electrolyte to penetrate the current collectors. Alternatively, the current collector may be a foil. Current collectors may include a coating, such as a carbon-based coating.

In some embodiments, the electrode assembly is a positive electrode assembly (cathode) and the current collector includes aluminum. In some embodiments, the electrode assembly is negative electrode assembly (anode) and the current collector includes copper, nickel, or both.

An electrode assembly that includes a coated electrode active material may be formed using known methods. For example, the known slurry method may be used to form the electrode assembly. In such an example, the electrode active material is coated via plasma polymerization (e.g., using PECVD), the coated electrode active material is included in a mixture of a binder, a filler (if present), and a wetting solvent (if present). The mixture, or slurry, is applied to the current collector.

The electrode composite 24 and the current collector 22 may have any suitable configuration. For example, the electrode composite 24 may surround the current collector 20. The electrode composite 24 may contact a single surface of the current collector. Suitable current collector-electrode composite configurations may be selected based on structural support of the respective electrode, proximity to one or more reaction zones of the electrode composite or electrode active material, or case of manufacturing, as just a few examples.

### Coated Electrode Assemblies

In some embodiments, the coating is applied to an electrode assembly. Stated differently, the present disclosure describes coated electrode assemblies. For example, in some embodiments, the bulk material 14 of FIG. 1 is an electrode assembly. The electrode assembly may be of any form factor. For example, the electrode assembly may be planar or non-planar. The coating may be any coating described herein having any characteristic or property described herein.

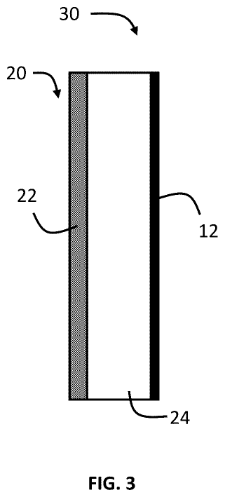

A cross-section side view of an illustrative coated electrode assembly 30 is shown in FIG. 3. The coated electrode assembly 30 includes an electrode assembly 20. The electrode assembly 20 includes a current collector 22 and an electrode composite 24. The current collector 20 is electrically coupled to the electrode composite 24. The current collector 22 and the electrode composite may be any current collector and electrode composite described herein. In some embodiments, the electrode composite includes an uncoated electrode active material. For example, the electrode composite may include any electrode active material, such as those described herein, that is not coated with a coating of the present disclosure.

The coated electrode assembly 30 includes a coating 12 of the present disclosure disposed on at least a portion of at least a surface of the electrode assembly. The electrode assembly 20 may be of any form factor. For example, the electrode assembly 20 may be planar or non-planar. As such, the coating 12 may be planar or nonplanar. In some embodiments, the coating 12 may be disposed on multiple surfaces of the electrode assembly 20. For example, in some embodiments, the coating 12 may be disposed on the electrode assembly 20 such that the coating 12 forms a shell surrounding an electrode assembly core.

The coating 12 of the coated electrode assembly 30 may be contacting the electrode composite, the current collector, or both. The coating 12 of the coated electrode assembly 30 may be contacting the binder, the filler, the electrode active material, or any combinations thereof.

A coated electrode assembly can be made by forming an electrode assembly 20 followed by application of a coating of the present disclosure. For example, the known slurry method may be used to form the electrode assembly. Once formed, the coating can be applied to at least a portion of a surface of the electrode assembly using plasma polymerization, for example, via PECVD.

### Method of Making the Coated Electrode Active Material and Coated Electrode Assemblies

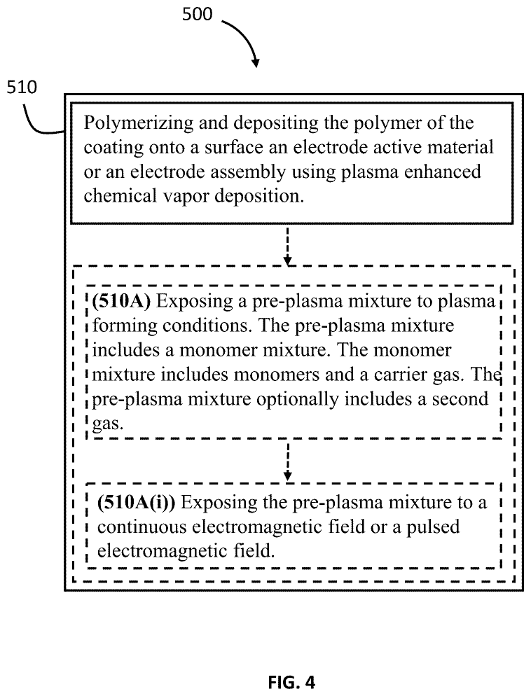

The preset disclosure describes methods of making the coated electrode active material and coated electrode assemblies of the present disclosure. FIG. 4 is a flow diagram of a method of forming the coated electrode active material or coated electrode assembly 500. The method 500 includes polymerizing and depositing the polymer of the coating onto a surface of electrode active material or a surface of an electrode assembly electrode active surface using plasma enhanced chemical vapor deposition (step 510). The polymer and the coating being any polymer and any coating as described herein.

In some embodiments, the method includes polymerizing and depositing the polymer of the coating onto the electrode active surface or the electrode assembly using plasma chemical vapor deposition. As such, the polymer of the coating is polymerized using plasma polymerization.

In some embodiments, the method includes polymerizing and depositing the polymer of the coating onto the electrode active surface or the electrode assembly via plasma enhanced chemical vapor deposition (PECVD).

In PECVD, gas phase and/or vapor phase monomers are introduced into a chamber containing plasma and a substrate (e.g., the electrode active material or electrode assembly). The plasma can be generated by applying an electromagnetic field to gases and/or monomers within the chamber. The monomers interact with the components of the plasma and/or the applied electromagnetic field being used to generate the plasma thereby facilitating polymerization of the monomers and deposition of the polymer onto the substrate. For example, the monomer may become activated through interaction with the applied electromagnetic field, gases present in the plasma, or both to facilitate polymerization of the monomers and deposition of the polymer onto the substrate. In some embodiments, the method includes exposing gaseous and/or vapor state monomers to a plasma to result in plasma polymerization of the polymer of the coating and deposition of the coating onto the substrate (e.g., an electrode active surface or an electrode assembly surface). In some embodiments, the method includes exposing gaseous and/or vapor state monomers to an electromagnetic field to result in the plasma polymerization of the polymer of the coating and deposition of the polymer of the coating onto a substrate (e.g., an electrode active surface or an electrode assembly surface).

In embodiments, the method step 510 includes exposing a pre-plasma mixture to plasma forming conditions (step 510A). Exposing a pre-plasma mixture to plasma forming conditions can create a plasma that includes reactive species formed from at least the gases in pre-plasma mixture. For example, plasma can be created by exposing a pre-plasma mixture to a constant or oscillating electromagnetic field. For example, a pre-plasma mixture can be exposed to an electromagnetic field generated by radiofrequency (RF) energy to generate plasma. The electromagnetic field can ionize gas molecules and/or monomer molecules resulting in plasma.

In some embodiments, the method includes exposing a pre-plasma mixture to an electromagnetic field. Exposing the pre-plasma mixture to an electromagnetic field can result in the formation of plasma. The plasma can include ionized pre-plasma mixture molecules, radicals of pre-plasma mixture molecules, and neutral pre-plasma mixture molecules. In some embodiments, the electromagnetic field is an oscillating electromagnetic field. In some embodiments, the electromagnetic field is generated by an electromagnetic field generator. In some embodiments, the electromagnetic field generator is a radiofrequency (RF) generator. The power applied to generate the electromagnetic field may vary. For example, the power applied to generate the electromagnetic field may be from 3 W to 300 W, for example, 5 W to 150 W. Without wishing to be bound by theory, with all other conditions being the same, it is thought that an electromagnetic field generated using a higher power will result in a polymer that has more branching and/or crosslinking than an electromagnetic field generating using lower power.

A pre-plasma mixture includes a monomer mixture. The monomer mixture includes the monomer and a carrier gas. In some embodiments when two monomers are being copolymerized, the monomer mixture includes the two monomers. In other embodiments when two or more monomers are being copolymerized there is a first monomer mixture that includes one monomer and a carrier gas and there is a second monomer mixture that includes another monomer and a carrier gas. The carrier gas may include one or more gases. The carrier gas may be used to vaporize the monomer or otherwise facilitate the monomer transitioning from a liquid phase to a gas and/or vapor phase. For example, the monomer may be operable coupled to the PECVD system via a bubbler set up and volatilized using bubbling of the carrier gas through the monomer liquid. In some embodiments where the monomer is a liquid, the carrier gas is used to volatilize the monomer. For example, the carrier gas can be bubbled through the liquid monomer to facilitate bringing the monomer into the gas and/or vapor phase. The carrier gas can be an inert gas. Examples of carrier gases include, for example, nitrogen gas, argon gas, helium gas, neon gas, krypton gas, xenon gas, radon gas, or any combinations thereof. In some embodiments, the carrier gas includes or consists of nitrogen gas.

In some embodiments, the pre-plasma mixture includes one or more gases in addition to the carrier gas. In some embodiments, the pre-plasma mixture includes a process gas. In some embodiments, a process gas is a gas that is not used, or not initially used, to bring a liquid monomer into the gas and/or vapor phase. For example, in some embodiments, a process gas is included in the pre-plasma mixture but is not bubbled or otherwise in contact with the liquid monomer prior to the liquid monomer being volatilized. In some embodiments, the process gas includes a reactive gas. The inclusion of a reactive gas may result in a polymer that includes atoms of the reactive gas. An example of a reactive gases is oxygen gas. In some embodiments, the process gas includes two or more gasses. For example, a process gas may include oxygen gas, nitrogen gas, argon gas, or any combinations thereof. In some embodiments, the process gas includes oxygen gas and argon gas. In some embodiments, the process gas includes oxygen gas and nitrogen gas.

In some embodiments where the pre-plasma mixture includes a monomer mixture and a process gas, the monomer mixture and the process gas may be mixed prior to being exposed to plasma forming conditions. In other embodiments, the monomer mixture and the process gas may not be mixed prior to being exposed to plasma forming condition.

In some embodiments, the pre-plasma mixture includes nitrogen gas, oxygen gas, argon gas, or any combination thereof. In some embodiments, the pre-plasma mixture includes oxygen gas. For example, in some embodiments, the pre-plasma mixture includes oxygen gas as a process gas. In some embodiments, the pre-plasma mixture includes oxygen gas and nitrogen gas. For example, in some embodiments, the pre-plasma mixture includes oxygen gas as a process gas and nitrogen gas as a carrier gas. In some embodiments, the pre-plasma mixture includes oxygen gas and argon gas. For example, in some embodiments, the pre-plasma mixture includes oxygen gas as a process gas and argon gas as a carrier gas. In some embodiments, the pre-plasma mixture includes oxygen gas. For example, in some embodiments, the pre-plasma mixture includes oxygen gas as a process gas.

In some embodiments, the pre-plasma mixture includes nitrogen as a carrier gas and oxygen as a process gas. In some embodiments, the pre-plasma mixture includes argon as a carrier gas and oxygen as a process gas. In some embodiments, the pre-plasma mixture includes argon gas and nitrogen as a carrier gas and oxygen as a process gas.

The gas composition of the pre-plasma mixture can be described by the mass percent (mass-%) of the gases in the mixture excluding the monomer. For example, the total mass of the gases (total gas mass) of the pre-plasma mixture is the sum or the carrier gas mass and the process gas mass (if present). In some embodiments, the pre-plasma mixture includes oxygen gas (e.g., as a process gas) in an amount of 10 mass-% or greater, 20 mass-% or greater, 30 mass-% or greater, 40 mass-% or greater, 50 mass-% or greater, 60 mass-% or greater, 70 mass-% or greater, or 80 mass-% or greater of the total gas mass. In some embodiments, the pre-plasma mixture includes oxygen gas (e.g., as a process gas) in an amount of 90 mass-% or less, 80 mass-% or less, 70 mass-% or less, 60 mass-% or less, 50 mass-% or less, 40 mass-% or less, 30 mass-% or less, or 20 mass-% or less of the total gas mass. In some embodiments, the pre-plasma mixture includes oxygen gas (e.g., as a process gas) in an amount of 30 mass-% to 80 mass-% such as 40 mass-% to 80 mass-% or 70 mass-% to 80 mass-% of the total gas mass . . .

In some embodiments, the pre-plasma mixture includes nitrogen gas (e.g., as a carrier gas) in an amount of 5 mass-% or greater, 10 mass-% or greater, 20 mass-% or greater, 30 mass-% or greater, 40 mass-% or greater, 50 mass-% or greater, 60 mass-% or greater, 70 mass-% or greater, 80 mass-% or greater, or 90 mass-% or greater of the total gas mass. In some embodiments, the pre-plasma mixture includes nitrogen gas (e.g., as a carrier gas) in an amount of 100 mass-% or less, 90 mass-% or less, 80 mass-% or less, 70 mass-% or less, 60 mass-% or less, 50 mass-% or less, 40 mass-% or less, 30 mass-% or less, 20 mass-% or less, or 10 mass-% or less of the total gas mass. In some embodiments, the pre-plasma mixture includes oxygen gas (e.g., as a carrier gas) in an amount of 5 mass-% to 50 mass-% such as 5 mass-% to 40 mass-%, 10 mass-% to 30 mass-%, or 20 mass-% to 40 mass-% of the total gas mass.

In some embodiments, the content of the pre-plasma mixture may impact the structure of the polymer. For example, in some embodiments where a polymer is plasma polymerized in the presence plasma formed from oxygen gas (e.g., the pre-plasma mixture include oxygen gas, as, for example, a process gas), the resultant polymer may be oxidized or more highly oxidized than a polymer polymerized under the same conditions but without oxygen gas (e.g., the pre-plasma mixture did not include oxygen gas). As such, it is understood that any plasma polymerized polymer of the present disclosure may be oxidized, particularly when the pre-plasma mixture includes oxygen (e.g., as a process gas).

In some embodiments, a coated electrode active material or coated electrode assembly includes a coating that includes a plasma polymerized polymer formed from exposure to a plasma formed from a pre-plasma mixture that included monomers, a carrier gas, and oxygen (e.g., as a process gas). The composition of the pre-plasma mixture may be any composition disclosed herein. For example, the pre-plasma mixture may include oxygen gas in an amount of 30 mass-% to 80 mass-% such as 40 mass-% to 80 mass-% or 70 mass-% to 80 mass-% by mass of the gases (the sum of the carrier gas and process gas, total gas mass).

The composition of the pre-plasma mixture can be at least partially controlled through adjusting the flow rate of the monomer mixture and/or the process gas of the pre-plasma mixture. The pre-plasma mixture or the components of the pre-plasma mixture (e.g., the monomer mixture and the process gas) are generally introduced into the chamber at a flow rate. The amount of each component of the pre-plasma mixture (e.g., the monomer mixture and process gas (if present)) introduced can be controlled, for example, using mass flow controllers. For example, mass flow controllers can be used to accomplish the desired mass-% of each gas (e.g., carrier gas and process gas (if present)) in the pre-plasma mixture.

The flow rate of the pre-plasma mixture or the components of the pre-plasma mixture (e.g., the monomer mixture and the process gas) may depend at least in part on desired plasma chamber pressure. In some embodiments, the plasma chamber pressure is 0.1 mbar to 1 mbar. Typical pre-plasma mixture mass flow rates or components of the pre-plasma mixture (e.g., the monomer mixture and the process gas) mass flow rates may range from 0 sccm to 200 sccm dependent on the desired chamber pressure.

The flow rate of the pre-plasma mixture or the components of the pre-plasma mixture (e.g., the monomer mixture and the process gas) may depend at least in part on the desired amount of the monomer being exposed to plasma forming conditions at any particular time. The flow rate of the monomer mixture can be used as a proxy to generalize the amount of monomer in the chamber at any particular time. Without wishing to be bound by theory, with all other conditions being the same, a higher flow rate of the monomer mixture results in a higher concentration of the monomer in the chamber. Additionally, without wishing to be bound by theory, with all other conditions being the same, a higher flow rate of the monomer mixture may result in a polymer with less branching and/or crosslinking compared to a lower flow rate.

PECVD may be done under continuous wave plasma conditions or pulsed wave plasma conditions. In some embodiments, continuous wave plasma conditions and pulse waved conditions may be done sequentially or alternated to form a coating having various layers. In continuous wave plasma conditions, also called continuous PECVD, the pre-plasma mixture is continuously exposed to plasma forming conditions. For example, the pre-plasma mixture entering the chamber is continuously exposed to an electromagnetic field. In some embodiments, the pre-plasma mixture is continuously exposed to an electromagnetic field generated by RF energy. Without wishing to be bound by theory, with all other conditions being the same, it is thought that continuous PECVD may result in polymer that has more branching and/or crosslinking than pulsed PECVD.

In some embodiments, the method step 510A includes exposing the pre-plasma mixture to a continuous electromagnetic field (step 510A(i)). In other embodiments, the method step 510A includes exposing the pre-plasma mixture to a pulsed electromagnetic field (step 510A(i)).

In continuous wave conditions the polymer structure and deposition rate are thought to depend at least in part on the power used to generate the electromagnetic field and monomer mixture flow. Without wishing to be bound by theory, it is thought that employing a condition with a relatively high monomer mixture flow and where the deposition rate is thought to be limited by the power used to generate the electromagnetic field may allow for higher retention of monomer functional groups. The polymers generated under these conditions may have lower degree of branching and crosslinking compared to a lower monomer mixture flow rate and higher electromagnetic field power forming conditions.

In some embodiments, the method includes pulsed wave plasma conditions. In pulsed wave plasma conditions, also called pulsed PECVD, the means for forming plasma from the pre-plasma mixture are cycled on and off. As such, in pulsed PECVD, the pre-plasma mixture is not continuously exposed to plasma forming conditions. As such, the plasma is cycled on and off. For example, if the plasma is being formed by exposing the pre-plasma mixture to an electromagnetic field generated by RF energy, the RF energy source can be cycled on and off.

In pulsed PECVD, the duty cycle can vary. The duty cycle is the ratio of the pulse duration (plasma forming condition on) to the total cycle (plasma forming condition on duration and the plasma forming condition off duration) given as a percent. Modification of the duty cycle may change the polymer structure and coating deposition rate. For example, it is thought that the short plasma forming condition on periods (small duty cycles) may generate gaseous reactive species which react with each other during the plasma forming condition off periods leading to deposition onto the substrate (e.g., electrode active material or electrode assembly). For example, during short plasma forming condition on times, monomer can be activated and allowed to form longer chain polymers during plasma off periods while minimizing the destruction of the ethylene bonds.

When pulse PECVD is employed, the duty cycle can be, for example, 0.1% to 20%. In some embodiments, the duty cycle can be 0.1% or greater, 0.25% or greater, 0.5% or greater, 0.75% or greater, 1% or greater, 2% or greater, 3% or greater, 4% or greater, 5% or greater, 10% or greater, or 15% or greater. In some embodiments, the duty cycle can be 20% or less, 15% or less, 10% or less, 5% or less, 4% or less, 3% or less, 2% or less, 1% or less, 0.75% or less, 0.5% or less, or 0.25% or less. In some embodiments, the duty cycle can be 0.1% to 5% such as 0.5% to 1%, 0.5% to 1.5%, 1% to 5%, 1% to 4%, 1% to 3%, 1% to 2%, 2% to 5%, or 2% to 4%.

In some embodiments, the method includes flowing the pre-plasma mixture into a chamber. The chamber can house the substrate to which the polymer of the coating is to be disposed. For example, the electrode active material or electrode assembly is within the chamber. The chamber can be a part of a PECVD system. The chamber may be pressure and/or temperature controlled. The flow of the pre-plasma mixture into the chamber may be continuous or pulsed. In embodiments where the pre-plasma mixture includes a process gas not in contact with the monomer prior to the monomer being volatilized, the monomer mixture and the process gas may be flowed into the chamber independently. At least a portion of the pre-plasma mixture within the chamber can be exposed to plasma forming conditions such as the plasma forming conditions described herein.

### Electrochemical Cell

The present disclosure further describes electrochemical cells. At least one electrode of the electrochemical cell includes the coated electrode active material or coated electrode assembly of the present disclosure. The electrode assemblies that include a coated electrode active material or the coated electrode assemblies of the present disclosure may be used in any type of electrochemical cell. In some embodiments, the electrochemical cell is a lithium-ion cell. The electrochemical cell can have any configuration, for example, a cylindrical configuration, a prismatic configuration, a button/coin configuration, or a pouch configuration.

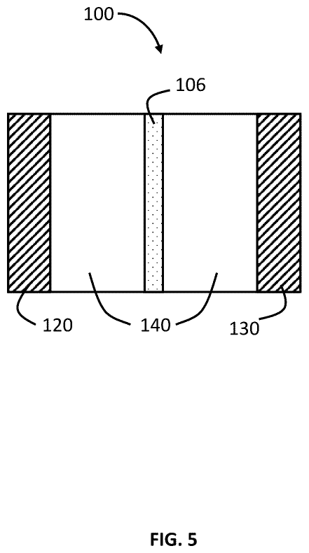

A cross-section side view of an illustrative electrochemical cell 100 is shown in FIG. 5. The electrochemical cell 100 includes a negative electrode assembly 120 and a positive electrode assembly 130. The negative electrode assembly 120, the positive electrode assembly 130, or both, include an electrode assembly that includes a coated electrode active material described herein and/or a coated electrode assembly described herein. In some embodiments, the negative electrode assembly 120 includes an electrode assembly containing a coated electrode active material described herein. In some embodiments, the negative electrode assembly 120 includes a coated electrode assembly described herein. In some embodiments, the positive electrode assembly includes an electrode assembly containing a coated electrode active material described herein. In some embodiments, the positive electrode assembly includes a coated electrode assembly described herein. The electrochemical cell 100 may include a separator 106 between the negative electrode assembly 120 and the positive electrode assembly 130. The electrochemical cell 100 may include electrolyte 140. The electrochemical cell 100 may be at least partially disposed within a housing (not shown).

The electrochemical cell can include a separator 106. The separator 106 is generally configured to inhibit direct interaction between the negative electrode assembly 120 and the positive electrode assembly 130, thus limiting the likelihood of internal short circuits. The separator is also generally configured to allow for the transport of ions between the negative electrode assembly 120 and the positive electrode assembly 130. Any suitable separator 106 may be used including, for example, polymeric porous membranes such as polyethylene, polypropylene (CELGARD); modified polymeric membranes with thin oxide coatings of titania (TiO₂), zinc oxide (ZnO), and/or silica (SiO₂); and hybrid organic-organic assemblies such as those that contain SiO₂ nanoparticles covalently tethered within a polymeric network such as poly(urethanes), poly(acrylates), and poly(ethylene glycol). In some embodiments, more than one separator may be used.

The electrochemical cell 100 includes an electrolyte 140. The electrolyte may facilitate ion transfer between opposite-polarity electrodes, such as between a negative electrode assembly and a positive electrode assembly. The electrolyte may have an electrical potential. The electrolyte may include any suitable material and may be one or more of, for example, a liquid, a gel, a solid, or a paste. The material composition of the electrolyte may include, for example, a lithium salt, a fluorinated sulfone, and/or any other suitable electrolyte. The electrolyte may include a non-aqueous solution in which a lithium salt (for example, lithium hexafluorophosphate salt) is dissolved in an organic carbonate solvent (such as, for example, mixtures including one or more of ethylene carbonate, dimethyl carbonate, propylene carbonate, diethyl carbonate, or ethyl methyl carbonate). In some embodiments, the electrolyte is a solid electrolyte. Examples of solid electrolytes include sodium (Na) super ionic conductor (NASICON-type), lithium phosphorus oxynitride (LiPON), poly(ethlyene oxide) with additives such as LiTFSI, or any combination thereof. Additional examples of solid electrolytes include those described in (A) Beata Kurc, Composite gel polymer electrolyte with modified silica for LiMn₂O4 positive electrode in lithium-ion battery, Electrochimica Acta, Volume 190, 2016, Pages 780-789, ISSN 0013-4686, doi.org/10.1016/j.electacta.2015.12.175; (B) Chao Li, Ying Huang, Xuansheng Feng, Zheng Zhang, Heng Gao, Jiaxin Huang, Silica-assisted cross-linked polymer electrolyte membrane with high electrochemical stability for lithium-ion batteries, Journal of Colloid and Interface Science, Volume 594, 2021, Pages 1-8, ISSN 0021-9797, doi.org/10.1016/j.jcis.2021.02.128; (C) Changyu Tang, Ken Hackenberg, Qiang Fu, Pulickel M. Ajayan, Halch Ardebili, High Ion Conducting Polymer Nanocomposite Electrolytes Using Hybrid Nanofillers, Nano Letters, 2012, doi: 10.1021/nl202692y; (D) Asghar MR, Anwar MT, Naveed A, Zhang J. A Review on Inorganic Nanoparticles Modified Composite Membranes for Lithium-Ion Batteries: Recent Progress and Prospects. Membranes (Basel). 2019 Jul. 2, 9 (7): 78. doi: 10.3390/membranes9070078. PMID: 31269768, PMCID: PMC6680444; and (E) Pravin N. Didwal, Y. N. Singhbabu, Rakesh Verma, Bong-Jun Sung, Gwi-Hak Lec, Jong-Sook Lec, Duck Rye Chang, Chan-Jin Park, An advanced solid polymer electrolyte composed of poly(propylene carbonate) and mesoporous silica nanoparticles for use in all-solid-state lithium-ion batteries, Energy Storage Materials, Volume 37, 2021, Pages 476-490, ISSN 2405-8297, doi.org/10.1016/j.ensm.2021.02.034.

In some embodiments, the electrochemical cell may be at least partially disposed in a housing. Although not explicitly shown in the figures, the housing may generally enclose the components of the electrochemical cell and contain the electrolyte within the housing. At least portions of at least some components may not be enclosed by the housing. Portions of each of the one or more current collectors may not be enclosed by the housing, as an example.

The housing may include any suitable material or combination of materials. Suitable housing materials may include aluminum, titanium, stainless steel, nickel, and nickel coated ferrous steels, as examples. In one or more embodiments, the housing may include a polymeric material.

### Electrochemical Performance Properties

The properties of a coated electrode active material and/or coated electrode assembly may impact the electrochemical properties of an electrochemical cell. The electrochemical properties of a coated electrode active material or coated electrode assembly can be evaluated when a coated electrode active material or coated electrode assembly is included in a working electrode assembly of a half cell. Half cells include a working electrode assembly and a counter electrode assembly. The working electrode assembly is the limiting electrode assembly and the electrode assembly for which the properties are being evaluated. The counter electrode assembly completes the electrochemical cell but does not limit the rate of the electrochemical reaction and it may also function as a pseudo-reference electrode assembly. As such, use of a coated electrode active material and/or a coated electrode assembly in or as the working electrode assembly in a half cell can be used to measure or derive various electrochemical properties of a coated electrode active material and/or coated electrode assembly. Examples of electrochemical performance properties include specific capacity, average discharge voltage, capacity retention, and irreversible capacity loss. Unless otherwise stated, the electrochemical performance properties (e.g., specific capacity, average discharge voltage, capacity retention, and irreversible capacity loss) are described when a coated electrode active material, a composite including a coated electrode active material, an electrode assembly including a coated electrode active material, or a coated electrode assembly is included in, or is, the working electrode assembly of a half cell.

Specific capacity is the amount of energy in an electrode active material compared to the mass of the electrode active material and may be expressed, for example, as milliamperes-hours per gram of electrode active material (mAh/g or mAh g⁻¹). Specific capacity is dependent at least in part on the electrode active material. The specific capacity of the coated electrode active material, composite including the same, or electrode assembly containing the same can be measured according to the Specific Capacity Test Method (see the Test Methods described herein). In some embodiments, the coated electrode active material of the present disclosure may have improved or specific capacity compared to the same, but uncoated, electrode active material. For instance, LiₓNi_{0.6}Mn_{0.2}Co_{0.2}O₂ has a theoretical specific capacity of 277 mAh/g, however, in practical applications the achieved capacity is 172 mAh/g. Application of a coating may help to increase the practically achievable specific capacity closer to the theoretical value.

Electrochemical cells that include a coated electrode active material, a composite including a coated electrode active material, an electrode assembly including a coated electrode active material, or a coated electrode assembly may display high cycling stability. For example, such electrochemical cells may have a high-capacity retention and/or a high discharge rate retention. High-capacity retentions and/or high-rate retentions may allow the electrochemical cell to meet the capacity and power needs of various devices.

Capacity retention measures an electrode assembly's specific capacity over the course of multiple charge-discharge cycles as a percentage of the electrode assembly's specific capacity in the electrode assembly's first cycle or as a percentage of the average specific capacity of the first three cycles. Capacity retention can be measured according to the Capacity Retention Test Method (see the Test Methods described herein). In some embodiments, the coated electrode active material and/or coated electrode assembly of the present disclosure may have improved or similar capacity retention compared to the same, but uncoated, electrode active material and/or uncoated electrode assembly. In some embodiments, a coated electrode active material, a composite including a coated electrode active material, an electrode assembly including a coated electrode active material, or a coated electrode assembly may have a capacity retention of 75% or greater, 80% or greater, 85% or greater, 90% or greater, 95% or greater, or 100% or greater as measured according to the Capacity Retention Test Method.

Electrochemical cells that include a coated electrode active material, a composite including a coated electrode active material, an electrode assembly including a coated electrode active material, or a coated electrode assembly may display good fast-charging performance. In some embodiments, the coated electrode active material of the present disclosure or coated electrode assembly may have improved or similar charge performance to the same, but uncoated electrode active material or uncoated electrode assembly. Charge performance can be assessed by the Capacity Retention C-rate Challenge Test Method. The Capacity Retention C-rate Challenge Test Method is similar to the Capacity Retention Test Method as both methods measure an electrode assembly's specific capacity over the course of multiple charge-discharge cycles as a percentage of the electrode assembly's specific capacity in the electrode assembly's first cycle or the average specific capacity of the first three cycles. Unlike the Capacity Retention Test Method in which the cell is subjected to the same C-rate through all charge-discharge cycles, the Capacity Retention C-rate Challenge Test Method includes cycling the cell at increasing C-rates. C-rate is a measure of the discharge rate relative to capacity and is calculated as the discharge current in Ampere divided by the specific capacity in Ampere-hours. The unit of C-rate is “C.” In the Capacity Retention C-rate Challenge Test Method, the specific capacity of an electrode assembly at an initial C-rate is compared to the specific capacity of the electrode assembly when discharged at the initial C-rate after being subjected to discharge at various increasing C-rates. In some embodiments, a coated electrode active material, a composite including a coated electrode active material, an electrode assembly including a coated electrode active material, or a coated electrode assembly has a discharge capacity at 0.1 C that is 50% or greater, 60% or greater, 70% or greater, 80% or greater, or 90% or greater than the discharge capacity of the same cell 0.1 C prior to subjecting the cell to discharging at increased C-rates according to the Capacity Retention C-rate Challenge Test Method.

### ILLUSTRATIVE EMBODIMENTS

The following is a list of illustrative embodiments according to the present disclosure.

Embodiment A1 is a coated electrode active material. The coated electrode active material includes an electrode active material and a coating disposed on the surface of the electrode active material. The coating may be a continuous, conformal coating. The coating may have a thickness of 100 nm or less as measure via the Thickness Test Method. The coating includes a plasma polymerized polymer. The polymer may be electrically conductive, ionically conductive, or both.

Embodiment A2 is the coated electrode active material of Embodiment A1, where the plasma polymerized polymer was polymerized in the presence of plasma formed from a pre-plasma mixture that included oxygen.

Embodiment A3 is the coated electrode active material of Embodiment A1 or A2, where the coating has an electronic conductivity of 0.01 S/m or greater. In some embodiments, the coating has an electronic conductivity of 0.1 S/m or greater. In some embodiments, the coating has an electronic conductivity of 0.5 S/m or greater. In some embodiments, the coating has an electronic conductivity of or 1 S/m or greater. Electronic conductivity is measured according to the Electronic Conductivity Test Method.

Embodiment A4 is the coated electrode active material of Embodiment A3, wherein the coating has an electronic conductivity of 1 S/m or greater. In some embodiments, the coating has an electronic conductivity of 1 S/m to 10 S/m.

Embodiment A5 is a coated electrode active material. The coated electrode active material includes an electrode active material and a coating disposed on a surface of the electrode active material. The coating may be a continuous, conformal coating. The coating may have a thickness of 100 nm or less as measured via the Thickness Test Method. The coating includes an electrically conductive and/or ionically conductive polymer. The coating has an electronic conductivity of 1 S/m or greater as measured according to the Electronic Conductivity Test Method.

Embodiment A6 is the coated electrode active material of any one of Embodiments A1 to A5 where the coating has a thickness of 50 nm or less. In some embodiments, the coating has a thickness of 25 nm or less. In some embodiments, the coating has a thickness of 10 nm or less. In some embodiments, the coating has a thickness of 5 nm or less. In some embodiments, the coating has a thickness of 1 nm or less. Thickness is measured via the Thickness Test Method.

Embodiment A7 is the coated electrode active material of any one of Embodiments A1 to A6, where the electrode active material is a positive electrode active material.

Embodiment A8 is the coated electrode active material of any one of Embodiments A1 to A7, where the electrode active material includes lithium cobalt oxide; lithium iron phosphate; lithium manganese oxide; lithium nickel cobalt aluminum oxides; lithium nickel oxide; lithium nickel manganese cobalt oxides; lithium manganese oxides; or any combinations thereof.

Embodiment A9 is the coated electrode active material of any one of Embodiments A1 to A6, where the electrode active material is a negative electrode active material.

Embodiment A10 is the coated electrode active material of any one of Embodiments A1 to A6 or A9, where the electrode active material includes graphite, silicon-graphite mixtures, lithium titanium oxide, transition metal chalcogenides, transition metal carbides, transition metal oxides, transition metal phosphides, binary transition metal oxides, aluminum niobates, titanium niobates, or any combinations thereof.

Embodiment A11 is the coated electrode active material of any one of Embodiments A1 to A10, where the electrically conductive polymer is polymerized from a hydrocarbon monomer that includes an aromatic group; an acyclic hydrocarbon monomer; a heteroaromatic monomer; a heteroaryl monomer; a mixed heteroatom containing monomer; or any combination thereof. In some embodiments, the electrically conductive polymer is copolymerized from a first monomer and a second monomer. In some embodiments, the first monomer includes a hydrocarbon monomer including an aromatic group; an acyclic hydrocarbon monomer; a heteroaromatic monomer; a heteroaryl monomer; a mixed heteroatom containing monomer; or any combination thereof. In some embodiments, the second monomer includes a poly(tetrahedral silsesquioxane), a hydroborane, a borane cluster, or any combination thereof.

Embodiment A12(i) is the coated electrode active material of Embodiment A11, wherein the hydrocarbon monomer that includes an aromatic group is fluorene, phenylene, pyrene, azulene, naphthalene, or styrene.

Embodiment A12(ii) is the coated electrode active material of any one of Embodiments A1 to A12(i), where the polymer includes poly(fluorene), poly(phenylene), poly(pyrene), poly(azulene), poly(naphthalene), poly(styrene), any combinations thereof, or any oxidized derivatives thereof.

Embodiment A13(i) is the coated electrode active material of Embodiment A11, wherein the acyclic hydrocarbon monomer is acetylene.

Embodiment A13(ii) is the coated electrode active material of any one of Embodiments A1 to A13(i), where the polymer includes poly(acetylene) or an oxidized derivative thereof.

Embodiment A14(i) is the coated electrode active material of Embodiment A11, where the heteroaromatic monomer is pyrrole, carbazole, indole, azepine, or thiophene.

Embodiment A14(ii) is the coated electrode active material of any of Embodiment A1 to A11 or A14(i), where the polymer includes poly(pyrrole), poly(carbazole), poly(indole), poly(azepine), poly(thiophene), any combinations thereof, or any oxidized derivatives thereof.

Embodiment A15(i) is the coated electrode active material of Embodiment A11, where the heteroaryl monomer is phenol, aniline, or phenyl sulfide.

Embodiment A15(ii) is the coated electrode active material of any one of Embodiments A1 to A10 or A15(ii), where the polymer includes poly(phenol), poly(aniline), poly(phenyl sulfide), any combinations thereof, or any oxidized derivatives thereof.

Embodiment A16(i) is the coated electrode active material of Embodiment A11, where the mixed heteroatom containing monomer is 3,4-ethylenedioxythiophene.

Embodiment A16(ii) is the coated electrode active material of any one of Embodiments A1 to A10 or A16(i), where the polymer includes poly(3,4-ethylenedioxythiophene) or an oxidized derivative thereof.

Embodiment A17 is the coated electrode active material of any one of Embodiments A1 to A16, where the variability in thickness (coating thickness variability) of the coating is within 10% of the average thickness according to the Thickness Variability Test Method. In some embodiments, the variability in thickness (coating thickness variability) of the coating is within 5% of the average thickness according to the Thickness Variability Test Method. In some embodiments, the variability in thickness (coating thickness variability) of the coating is within 2.5% of the average thickness according to the Thickness Variability Test Method. In some embodiments, the variability in thickness (coating thickness variability) of the coating is within 1% of the average thickness according to the Thickness Variability Test Method.

Embodiment B1 is a coated electrode active material. The coated electrode active material includes an electrode active material and a coating disposed on a surface of the electrode active material. The coating may be a continuous, conformal coating. The coating has a thickness of 100 nm or less as measured according to the Thickness Test Method. The coating includes a plasma polymerized electrically and ionically conductive polymer. The coated electrode active material is formed by a method that includes polymerizing and depositing the polymer of the coating onto the electrode active surface using plasma enhanced chemical vapor deposition. Embodiment B2 is the coated electrode active material of Embodiment B1, where the plasma polymerized polymer was polymerized in the presence of plasma formed from a pre-plasma mixture that included oxygen.

Embodiment B3 is the coated electrode active material of Embodiment B1 or B2, where the coating has an electronic conductivity of 0.01 S/m or greater. In some embodiments, the coating has an electronic conductivity of 0.1 S/m or greater. In some embodiments, the coating has an electronic conductivity of 0.5 S/m or greater. In some embodiments, the coating has an electronic conductivity of or 1 S/m or greater. Electronic conductivity is measured according to the Electronic Conductivity Test Method.

Embodiment B4 is the coated electrode active material of Embodiment B3, where the coating has an electronic conductivity of 1 S/m or greater. In some embodiments, the coating has an electronic conductivity of 1 S/m to 10 S/m.

Embodiment B5 is a coated electrode active material. The coated electrode active material includes an electrode active material disposed on a surface of an electrode active material. The coating can be continuous, conformal coating disposed on a surface of the electrode active material. The coating has a thickness of 100 nm or less as measured according to the Thickness Test Method. The coating includes an electrically and ionically conductive polymer. The coating has an electronic conductivity of 1 S/m or greater as measuring according to the Electronic Conductivity Test Method. The coated electrode active material is formed by a method that includes polymerizing and depositing the polymer of the coating onto the electrode active surface using plasma enhanced chemical vapor deposition. Embodiment B6 is a coated electrode active material of any one of Embodiments B1 to B5, where polymerizing and depositing the polymer of the coating includes exposing a pre-plasma mixture to plasma forming conditions, the pre-plasma mixture including a monomer to be polymerized and a carrier gas.

Embodiment B7 is a coated electrode active material Embodiments B6, wherein the carrier gas includes nitrogen gas, argon gas, helium gas, or any combinations thereof.

Embodiment B8 is the coated electrode active material of Embodiment B6 or B7, where exposing a pre-plasma mixture to plasma forming conditions includes exposing the pre-plasma mixture to a continuous electromagnetic field.

Embodiment B9 is the coated electrode active material of Embodiment B6 or B7, where exposing a pre-plasma mixture to plasma forming conditions includes exposing the pre-plasma mixture to a pulsed electromagnetic field.

Embodiment B10 is the coated electrode active material of any one of Embodiments B1 to B9, where the coating has a thickness of 50 nm or less. In some embodiments, the coating has a thickness of 25 nm or less. In some embodiments, the coating has a thickness of 10 nm or less. In some embodiments, the coating has a thickness of 5 nm or less. In some embodiments, the coating has a thickness of 1 nm or less. Thickness is measured via the Thickness Test Method.

Embodiment B11 is the coated electrode active material of any one of Embodiments B1 to B10, where the electrode active material is a positive electrode active material.

Embodiment B12 is the coated electrode active material of any one of Embodiments B1 to B11, where the electrode active material includes lithium cobalt oxide; lithium iron phosphate; lithium manganese oxide; lithium nickel cobalt aluminum oxides; lithium nickel oxide; lithium nickel manganese cobalt oxides; lithium manganese oxides; or any combination thereof.

Embodiment B13 is the coated electrode active material of any one of Embodiments B1 to B10, where the electrode active material is a negative electrode active material.

Embodiment B14 is the coated electrode active material of any one of Embodiments B1 to B10 or B13, where the electrode active material includes graphite, silicon-graphite mixtures, lithium titanium oxide, transition metal chalcogenides, transition metal carbides, transition metal oxides, transition metal phosphides, binary transition metal oxides, aluminum niobates, titanium niobates, or any combinations thereof.

Embodiment B15 is the coated electrode active material of any one of Embodiments B1 to B14, where the electrically conductive polymer is polymerized from a hydrocarbon monomer that includes an aromatic group; an acyclic hydrocarbon monomer; a heteroaromatic monomer; a heteroaryl monomer; a mixed heteroatom containing monomer; or any combinations thereof. In some embodiments, the electrically conductive polymer is copolymerized from a first monomer and a second monomer. In some embodiments, the first monomer includes a hydrocarbon monomer including an aromatic group; an acyclic hydrocarbon monomer; a heteroaromatic monomer; a heteroaryl monomer; a mixed heteroatom containing monomer; or any combination thereof. In some embodiments, the second monomer includes and the second monomer includes a polytetrahedral silsesquioxane, a hydroborane, a borane cluster, or any combination thereof.

Embodiment B16(i) is the coated electrode active material of Embodiment B15, where the hydrocarbon monomer that includes an aromatic group is fluorene, phenylene, pyrene, azulene, naphthalene, or styrene.

Embodiment B16(ii) is the coated electrode active material of any one of Embodiments B1 to B15 or B16A(i), where the polymer includes poly(fluorene), poly(phenylene), poly(pyrene), poly(azulene), poly(naphthalene), poly(styrene), any combinations thereof, or any oxidized derivatives thereof.

Embodiment B17(i) is the coated electrode active material of Embodiment B15, where the acyclic hydrocarbon monomer is acetylene.

Embodiment B17(ii) is the coated electrode active material of any one of Embodiments B1 to B15 or B17(ii), where the polymer includes poly(acetylene) or an oxidized derivatives thereof.

Embodiment B18(i) is the coated electrode active material of Embodiment B15, where the heteroaromatic monomer is pyrrole, carbazole, indole, azepine, or thiophene.

Embodiment B18(ii) is the coated electrode active material of any of Embodiments B1 to B15 or B18(i), where the polymer includes poly(pyrrole), poly(carbazole), poly(indole), poly(azepine), poly(thiophene), any combinations thereof, or any oxidized derivatives thereof.

Embodiment B19(i) is the coated electrode active material of Embodiment B15, where the heteroaryl monomer is phenol, aniline, or phenyl sulfide.

Embodiment B19(ii) is the coated electrode active material of any one of Embodiments B1 to B15 or B19(i), where the polymer includes poly(phenol), poly(aniline), poly(phenyl sulfide), any combinations thereof, or any oxidized derivatives thereof.

Embodiment B20(i) is the coated electrode active material of Embodiment B15, where the mixed heteroatom containing monomer is 3,4-ethylenedioxythiophene.

Embodiment B20(ii) is the coated electrode active material of any one of Embodiments B1 to B15 or B20(i), where the polymer includes poly(3,4-ethylenedioxythiophene) or an oxidized derivative thereof.

Embodiment B21 is the coated electrode active material of any one of Embodiments B1 to B20, wherein variability in thickness is within 10% of the average thickness according to the Thickness Variability Test Method. In some embodiments, the variability in thickness (coating thickness variability) of the coating is within 5% of the average thickness according to the Thickness Variability Test Method. In some embodiments, the variability in thickness (coating thickness variability) of the coating is within 2.5% of the average thickness according to the Thickness Variability Test Method. In some embodiments, the variability in thickness (coating thickness variability) of the coating is within 1% of the average thickness according to the Thickness Variability Test Method.

Embodiment C1 is an electrode assembly. The electrode assembly includes a current collector and an electrode composite. The electrode composite includes the coated electrode active material of any one of Embodiments A1 to A17 or B1 to B21; an additive; and a binder.

Embodiments C2 is the electrode assembly of Embodiment C1, where the additive comprises carbon. In some embodiments, the additive includes carbon powder, carbon fiber, graphite, carbon nanotubes, graphene, graphyne, or any combinations thereof.

Embodiment C3 is the electrode assembly of Embodiment C1 or C2, where the binder includes poly(vinylidene fluoride).

Embodiment D1 is an electrochemical cell. The electrochemical cell includes a positive electrode assembly, a negative electrode assembly, a separator, and an electrolyte. At least one of the positive electrode assembly and the negative electrode assembly includes the electrode assembly of any one of Embodiments C1 to C3.

Embodiment D2 is the electrochemical cell of Embodiment D1, wherein the electrode assembly that includes the electrode assembly of any one of Embodiments C1 to C3 displays a specific capacity retention of 80% or greater. In some embodiments, the specific capacity retention is 85% or greater. In some embodiments, the specific capacity retention is 90% or greater. In some embodiments, the specific capacity retention is 95% or greater. Capacity retention is measured according to the Capacity Retention Test Method.

Embodiment E1 is a coated electrode assembly. The coated electrode assembly includes an electrode assembly and a coating disposed on a surface of the electrode assembly. The coating can be a continuous, conformal coating. The electrode assembly includes an electrode active material, a binder, and an additive. The coating has a thickness of 100 nm or less as measured via the Thickness Test Method. The coating includes a plasma polymerized polymer. The polymer may be electrically conductive, ionically conductive, or both.

Embodiment E2 is the coated electrode assembly of Embodiment E1, where the plasma polymerized polymer was polymerized in the presence of plasma formed from a pre-plasma mixture that included oxygen.

Embodiment E3 is the coated electrode assembly of Embodiment E1 or E2, where the coating has an electronic conductivity of 0.01 S/m or greater. In some embodiments, the coating has an electronic conductivity of 0.1 S/m or greater. In some embodiments, the coating has an electronic conductivity of 0.5 S/m or greater. In some embodiments, the coating has an electronic conductivity of or 1 S/m or greater. Electronic conductivity is measured according to the Electronic Conductivity Test Method.

Embodiment E4 is the coated electrode assembly of Embodiment E3, wherein the coating has an electronic conductivity of 1 S/m or greater. In some embodiments, the coating has an electronic conductivity of 1 S/m to 10 S/m.

Embodiment E5 is a coated electrode assembly. The coated electrode assembly includes an electrode assembly and coating disposed on a surface of the electrode assembly. The coating can be a continuous, conformal coating. The electrode assembly includes an electrode active material, a binder, and an additive. The coating has a thickness of 100 nm or less as measured via the Thickness Test Method. The coating includes an electrically conductive and ionically conductive polymer. The coating has an electronic conductivity of 1 S/m or greater as measured according to the Electronic Conductivity Test Method.

Embodiment E6 is the a coated electrode assembly of any one of Embodiments E1 to E5, where the coating has a thickness of 50 nm or less. In some embodiments, the coating has a thickness of 25 nm or less. In some embodiments, the coating has a thickness of 10 nm or less. In some embodiments, the coating has a thickness of 5 nm or less. In some embodiments, the coating has a thickness of 1 nm or less. Thickness is measured via the Thickness Test Method.

Embodiment E7 is the coated electrode assembly of any one of Embodiments E1 to E6, where the electrode active material is a positive electrode active material.

Embodiment E8 is the coated electrode assembly of any one of Embodiments E1 to E7, where the electrode active material includes lithium cobalt oxide; lithium iron phosphate; lithium manganese oxide; lithium nickel cobalt aluminum oxides; lithium nickel oxide; lithium nickel manganese cobalt oxides; lithium manganese oxides; or any combinations thereof.

Embodiment E9 is the coated electrode assembly of any one of Embodiments E1 to E6, where the electrode active material is a negative electrode active material.

Embodiment E10 is the coated electrode assembly of any one of Embodiments E1 to E6 or E9, where the electrode active material includes graphite, silicon-graphite mixtures, lithium titanium oxide, transition metal chalcogenides, transition metal carbides, transition metal oxides, transition metal phosphides, binary transition metal oxides, aluminum niobates, titanium niobates, or combination thereof.

Embodiment E11 is the coated electrode assembly of any one of Embodiments E1 to E10, where the electrically conductive polymer is polymerized from a hydrocarbon monomer that includes an aromatic group; an acyclic hydrocarbon monomer; a heteroaromatic monomer; a heteroaryl monomer; a mixed heteroatom containing monomer; or any combinations thereof. In some embodiments, the electrically conductive polymer is copolymerized from a first monomer and a second monomer. In some embodiments, the first monomer includes a hydrocarbon monomer including an aromatic group; an acyclic hydrocarbon monomer; a heteroaromatic monomer; a heteroaryl monomer; a mixed heteroatom containing monomer; or any combination thereof. In some embodiments, the second monomer includes s a polytetrahedral silsesquioxane, a hydroborane, a borane cluster, or any combinations thereof.

Embodiment E12(i) is the coated electrode assembly of Embodiment E11, where the hydrocarbon monomer that includes an aromatic group is fluorene, phenylene, pyrene, azulene, naphthalene, or styrene.

Embodiment E12(ii) is the coated electrode assembly of any one of Embodiments E1 to E10 or E12(i), where the polymer includes poly(fluorene), poly(phenylene), poly(pyrene), poly(azulene), poly(naphthalene), poly(styrene), any combinations thereof, or any oxidized derivatives thereof.

Embodiment E13(i) is the coated electrode assembly of Embodiment E11, where the acyclic hydrocarbon monomer is acetylene.

Embodiment E13(ii) is the coated electrode assembly of any one of Embodiments E1 to E10 or E13(i), where the polymer includes poly(acetylene) or an oxidized derivative thereof.

Embodiment E14(i) is the coated electrode assembly of Embodiment E11, where the heteroaromatic monomer is pyrrole, carbazole, indole, azepine, or thiophene.

Embodiment E14(ii) is the coated electrode assembly of any of Embodiment E1 to E11 or E14(i), where the polymer includes poly(pyrrole), poly(carbazole), poly(indole), poly(azepine), poly(thiophene), any combinations thereof, or any oxidized derivatives thereof.

Embodiment E15(i) is the coated electrode assembly of Embodiment E11, where the heteroaryl monomer is phenol, aniline, or phenyl sulfide.

Embodiment E15(ii) is the coated electrode assembly of any one of Embodiments E1 to E10 or E15(ii), where the polymer includes poly(phenol), poly(aniline), poly(phenyl sulfide), any combinations thereof, or any oxidized derivatives thereof.

Embodiment E16(i) is the coated electrode assembly of Embodiment E11, where the mixed heteroatom containing monomer is 3,4-ethylenedioxythiophene.

Embodiment E16(ii) is the coated electrode assembly of any one of Embodiments E1 to E10 or E16(i), where the polymer includes poly(3,4-ethylenedioxythiophene) or an oxidized derivative thereof.

Embodiment E17 is the coated electrode assembly of any one of Embodiments E1 to E16, where variability in thickness of the coating is within 10% of the average thickness according to the Thickness Variability Test Method. In some embodiments, the variability in thickness (coating thickness variability) of the coating is within 5% of the average thickness according to the Thickness Variability Test Method. In some embodiments, the variability in thickness (coating thickness variability) of the coating is within 2.5% of the average thickness according to the Thickness Variability Test Method. In some embodiments, the variability in thickness (coating thickness variability) of the coating is within 1% of the average thickness according to the Thickness Variability Test Method.

Embodiment F1 is a coated electrode assembly. The coated electrode assembly includes an electrode assembly and a coating disposed on a surface of the electrode assembly. The coating can be a continuous, conformal coating disposed. The electrode assembly includes an electrode active material, a binder, and an additive. The coating has a thickness of 100 nm or less as measured via the Thickness Test Method. The coating includes plasma polymerized electrically conductive and ionically conductive polymer. The coated electrode assembly is formed by a method including polymerizing and depositing the polymer of the coating onto the electrode assembly surface using plasma enhanced chemical vapor deposition.

Embodiment F2 is the coated electrode assembly of Embodiment F1, where the plasma polymerized polymer was polymerized in the presence of plasma formed from a pre-plasma mixture that included oxygen.

Embodiment F3 is the coated electrode active material of Embodiment F1 of F2, where the coating has an electronic conductivity of 0.01 S/m or greater. In some embodiments, the coating has an electronic conductivity of 0.1 S/m or greater. In some embodiments, the coating has an electronic conductivity of 0.5 S/m or greater. In some embodiments, the coating has an electronic conductivity of or 1 S/m or greater. Electronic conductivity is measured according to the Electronic Conductivity Test Method.

Embodiment F4 is the coated electrode active material of Embodiment F3, where the coating has an electronic conductivity of 1 S/m or greater. In some embodiments, the coating has an electronic conductivity of 1 S/m to 10 S/m.

Embodiment F5 is a coated electrode assembly. The coated electrode assembly includes an electrode assembly and a coating disposed on a surface of the electrode assembly. The coating can be a continuous, conformal coating. The electrode assembly includes an electrode active material, a binder, and an additive. The coating has a thickness of 100 nm or less as measured via the Thickness Test Method. The coating includes an electrically conductive and ionically conductive polymer. The coating has an electronic conductivity of 1 S/m or greater as measured according to the Electronic Conductivity Test Method. The coated electrode assembly is formed by a method including polymerizing and depositing the polymer of the coating onto the electrode assembly surface using plasma enhanced chemical vapor deposition.

Embodiment F6 is the coated electrode assembly of any one of Embodiments F1 to F5, where polymerizing and depositing the polymer of the coating includes exposing a pre-plasma mixture to plasma forming conditions, the pre-plasma mixture including a monomer to be polymerized and a carrier gas.

Embodiment F7 is the coated electrode assembly Embodiments F6, where the carrier gas includes nitrogen gas, argon gas, helium gas, or any combinations thereof.

Embodiment F8 is the coated electrode assembly of Embodiment F6 or F7, where exposing a pre-plasma mixture to plasma forming conditions includes exposing the pre-plasma mixture to a continuous electromagnetic field.

Embodiment F9 is the coated electrode assembly of Embodiment F6 or F7, where exposing a pre-plasma mixture to plasma forming conditions includes exposing the pre-plasma mixture to a pulsed electromagnetic field.

Embodiment F10 is the coated electrode assembly of any one of Embodiments F1 to F9, where the coating has a thickness of 50 nm or less. In some embodiments, the coating has a thickness of 25 nm or less. In some embodiments, the coating has a thickness of 10 nm or less. In some embodiments, the coating has a thickness of 5 nm or less. In some embodiments, the coating has a thickness of 1 nm or less. Thickness is measured via the Thickness Test Method.

Embodiment F11 is the coated electrode assembly of any one of Embodiments F1 to F10, where the electrode active material is a positive electrode active material.

Embodiment F12 is the coated electrode assembly of any one of Embodiments F1 to F11, where the electrode active material comprises lithium cobalt oxide; lithium iron phosphate; lithium nickel cobalt aluminum oxides; lithium manganese oxide; lithium nickel oxide; lithium nickel manganese cobalt oxides; lithium manganese oxides; or any combination thereof.

Embodiment F13 is the coated electrode assembly of any one of Embodiments F1 to F10, where the electrode active material is a negative electrode active material.

Embodiment F14 is the coated electrode assembly of any one of Embodiments F1 to F10 or F13, where the electrode active material includes graphite, silicon-graphite mixtures, lithium titanium oxide, transition metal chalcogenides, transition metal carbides, transition metal oxides, transition metal phosphides, binary transition metal oxides, aluminum niobates, titanium niobates, or combination thereof.

Embodiment F15 is the coated electrode assembly of any one of Embodiments F1 to F14, where the electrically conductive polymer is polymerized from a hydrocarbon monomer that includes an aromatic group; an acyclic hydrocarbon monomer; a heteroaromatic monomer; a heteroaryl monomer; a mixed heteroatom containing monomer; or any combination thereof. In some embodiments, the electrically conductive polymer is copolymerized from a first monomer and a second monomer. In some embodiments, the first monomer includes a hydrocarbon monomer including an aromatic group; an acyclic hydrocarbon monomer; a heteroaromatic monomer; a heteroaryl monomer; a mixed heteroatom containing monomer; or any combination thereof. In some embodiments, the second monomer includes a poly(tetrahedral silsesquioxane), a hydroborane, a borane cluster, or any combinations thereof.

Embodiment F16(i) is the coated electrode assembly of Embodiment F15, where the hydrocarbon monomer that includes an aromatic group is fluorene, phenylene, pyrene, azulene, naphthalene, or styrene.

Embodiment F16(ii) is the coated electrode assembly of any one of Embodiments F1 to F15 or F16A(i), where the polymer includes poly(fluorene), poly(phenylene), poly(pyrene), poly(azulene), poly(naphthalene), poly(styrene), any combinations thereof, or any oxidized derivatives thereof.

Embodiment F17(i) is the coated electrode assembly of Embodiment F15, where the acyclic hydrocarbon monomer is acetylene.

Embodiment F17(ii) is the coated electrode assembly of any one of Embodiments F1 to F15 or F17(ii), where the polymer includes poly(acetylene) or an oxidized derivative thereof.

Embodiment F18(i) is the coated electrode assembly of Embodiment F15, where the heteroaromatic monomer is pyrrole, carbazole, indole, azepine, or thiophene.

Embodiment F18(ii) is the coated electrode assembly of any of Embodiments F1 to F15 or F18(i), where the polymer includes poly(pyrrole), poly(carbazole), poly(indole), poly(azepine), poly(thiophene), any combinations thereof, or any oxidized derivatives thereof.

Embodiment F19(i) is the coated electrode assembly of Embodiment F15, where the heteroaryl monomer is phenol, aniline, or phenyl sulfide.

Embodiment F19(ii) is the coated electrode assembly of any one of Embodiments F1 to F15 or F19(i), where the polymer includes poly(phenol), poly(aniline), poly(phenyl sulfide), any combinations thereof, or any oxidized derivatives thereof.

Embodiment F20(i) is the coated electrode assembly of Embodiment F15, where the mixed heteroatom containing monomer is 3,4-ethylenedioxythiophene.

Embodiment F20(ii) is the coated electrode assembly of any one of Embodiments F1 to F15 or F20(i), where the polymer includes poly(3,4-ethylenedioxythiophene) or an oxidized derivative thereof.

Embodiment F21 is the coated electrode assembly of any one of Embodiments F1 to F20, wherein variability in thickness is within 10% of the average thickness according to the Thickness Variability Test Method. In some embodiments, the variability in thickness (coating thickness variability) of the coating is within 5% of the average thickness according to the Thickness Variability Test Method. In some embodiments, the variability in thickness (coating thickness variability) of the coating is within 2.5% of the average thickness according to the Thickness Variability Test Method. In some embodiments, the variability in thickness (coating thickness variability) of the coating is within 1% of the average thickness according to the Thickness Variability Test Method.

Embodiment G1 is an electrochemical cell. The electrochemical cell includes a positive electrode assembly, a negative electrode assembly, a separator, and an electrolyte. At least one of the positive electrode assembly and the negative electrode assembly includes the coated electrode assembly of any one of Embodiments E1 to E17 or F1 to F21.

Embodiment G2 is the electrochemical cell of Embodiment G1, wherein the electrode assembly comprising the electrode assembly of any one of Embodiments E1 to E17 or F1 to F21 displays a specific capacity retention of 80% or greater. In some embodiments, the specific capacity retention is 85% or greater. In some embodiments, the specific capacity retention is 90% or greater. In some embodiments, the specific capacity retention is 95% or greater. Capacity retention is measured according to the Capacity Retention Test Method.

### EXAMPLES

These Examples are merely for illustrative purposes and are not meant to be overly limiting on the scope of the appended claims. Notwithstanding that the numerical ranges and parameters setting forth the broad scope of the present disclosure are approximations, the numerical values set forth in the specific examples are reported as precisely as possible. Any numerical value, however, inherently contains certain errors necessarily resulting from the standard deviation found in their respective testing measurements. At the very least, and not as an attempt to limit the application of the doctrine of equivalents to the scope of the claims, each numerical parameter should at least be construed in light of the number of reported significant digits and by applying ordinary rounding techniques.

Unless otherwise noted, all parts, percentages, ratios, etc. in the examples and the rest of the specification are by weight. The following abbreviations may be used in the following examples and description: mL=milliliter; L=liter; m=meter; mm=millimeter; cm=centimeter; nm=nanometer, μm=micrometer, kg=kilogram; g=gram; min=minute; s=second; h=hour; ° C.=degrees Celsius; ° F.=degrees Fahrenheit; S=Siemen; wt-%=weight percent; M=molar; mol=mole; DI water=deionized water; C=C-rate; Amps of A=Amperes; mA=milliamperes; kΩ=kiloohms and V=volt.

### Test Methods

### Average Thickness Test Method:

The film thickness was determined using optical profilometry. A deposited film was first scratched with a blade such that a portion of the coating was removed from the surface without damage to the underlying substrate. A Keyence VK-X1000 Laser Confocal Microscope (available from Keyence Corp in Minnetonka, MN) was used to image the surface and for profilometry of the coating. A 150× microscope objective was focused onto the scratch made in the coating surface. The coating thickness was then determined by finding the difference in height between the coating surface and underlying substrate surface. The measurement was repeated a minimum of three times across the surface to determine the average thickness.

### Thickness Variability Test Method

The thickness variable parameter can be determined using the thickness measurements as described in the Thickness Test Method at multiple locations on the coated surface. For example, a blade can be used to remove a portion of the coating at several places (e.g., three) on the coated substrate. The thickness measurements can be used to create the parameter ΔT/T where ΔT is found by subtracting the minimum measured thickness from the maximum measured thickness and divided by the average coating thickness as determined according to the Thickness Test Method. This parameter can be used as a metric assess how uniform the coating was across the substrate surface.

### Electronic Conductivity Test Method:

The sheet resistance of the films was measured using a four-point probe (model T2001A3) available from Ossila in Shefield, United Kingdom. Reading from this instrument were verified using both a 10 kΩ test head and 400 nm fluorine-doped tin oxide sample (sheet resistance=12 ohms per square (Ω/square) included with the instrument. These standards were routinely checked to ensure the equipment was functioning as intended. Prior to any measurements the four-point probe was powered up and allowed to equilibrate for at least 30 minutes. Coatings were deposited onto a non-conductive substrate (e.g. glass wafers) and placed on the micrometer stage. To ensure accurate measurements but reduce the chance of sample damage the micrometer stage was raised such that the measurement probes were retracted to roughly half their resting length when contacted with the coated surface. The coating length, width, and thickness (as determined according to the Thickness Test Method) were used as inputs for the control software. The applied current of the outer probes and the measured voltage of the inner probes in combination with the geometric parameters of the coating were used to determine the sheet resistance, resistivity, and conductivity of the coatings. Measurements were taken with a voltage limit of 10.5 V and a current limit of 220 mA using a probe spacing of 1.270 mm. Recorded measurements were averaged over 50 data points for reporting in ohm/square or the sheet resistance values. These may be converted using the film thickness (as determined according to the Thickness Test Methods) into resistivity reported in ohm metre (Ω·m). Electronic conductivity is the reciprocal of resistivity and is reported in siemens per meter (S/m).

### Surface Coverage Test Method:

The coverage of a flat surface can be determined through a combination of optical microscopy imaging and scanning electron microscopy—energy-dispersive X-ray spectroscopy (SEM-EDX). A Keyence VK-X1000 Laser Confocal Microscope may be used to image the surface to determine the morphology of the coating across the substrate. These images may be stitched together to form a picture of the surface coverage. This may be combined with SEM-EDX to give information on the chemical composition of the coating at various points of the surface. This data may be indicative of the complete or incomplete surface coverage of the applied coating.

### Various Electrochemical Test Methods and Experiments:

### Test Half Cell:

An electrode assembly can be formed using a slurry casting method. In cases where the electrode assembly includes a coated electrode active material, the coated electrode active material is included in the slurry casting method. In cases where the electrode assembly is a coated electrode assembly, the electrode assembly can first be assembled and then coated.

An example slurry method for forming an electrode assembly that includes or does not include coated electrode active material is as follows. The electrode active material (e.g., cathode electrode active material) can be mixed using a FlakTek Speed Mixer with a conductive filler (Timcal Super C65 carbon black powder) and a solution of PVDF binder in N-methyl-2-pyrrolidone (NMP) solvent (e.g. Kureha 7208, 8 wt % PVDF (Mw 6.3×10⁵ g/mol), solution viscosity 2000 mPa·s, or MSE Supplies BR0210, 5% w/v PVDF, (Mw 1×10⁶ g/mol)). The composition of the cathode composite may be 3% w/w PVDF, 86% (w/w) to 94% (w/w) electrode active material and 3% (w/w) to 11% (w/w) C65. The compositions can be applied to a current collector. The cast assemblies can be dried at 80° C. in a vacuum oven for a minimum of 10 minutes until the majority of the NMP has evaporated and then at 50° C. overnight under dynamic vacuum.

CR2032 coin cells can be assembled in an Argon glovebox using 15 mm-diameter punch-outs of the electrode assembly described above and 15 mm-diameter lithium chip anodes (1 mm thickness) separated by a 19 mm-diameter Celgard 2320 (20 μm thickness). A commercially available liquid electrolyte can be used that includes 1 M LiPF₆ in 50/50 (v/v) EC/DEC.

### Specific Discharge Capacity Test Method:

The initial specific discharge capacity of the electrode assemblies can be determined through galvanostatic charged-discharge cycling using a constant current constant voltage method. Assembled coin cells can rested for 12 hours on the Neware battery testers (Neware technology LLC) followed by galvanostatic charge-discharged cycling with a voltage window of 3.0 V to 4.2 V. All battery testing can begin with three initial formation cycles followed by multiple cycles accelerated coin cell testing. This may be done using a current of 0.1 C rate during constant current conditions and a current of 0.01 C during constant voltage conditions for the formation cycles. Cycles 4 onwards of charging/discharging may be conducted at 1 C rate (accelerated coin cell testing ang aging) during constant current conditions and 0.01 C during constant voltage conditions. The current values can be determined using the expected specific charging capacity of the battery material.

### Capacity Retention Test Method:

The capacity retention can be calculated as the discharge capacity of the working electrode at a given cycle relative to the initial discharge capacity determined in the first three cycles of the charge-discharge program. That is, the capacity retention of the cathode material during any given cycle may be calculated as the ratio between the discharge capacity of the selected cycle relative to the average discharge capacity of the first three charge-discharge cycles. The discharge capacities can be obtained through the Specific Discharge Capacity Test Method described above.

### Capacity Retention C-Rate Challenge Test Method:

The rate capabilities of cathode materials can be tested under constant current conditions at varying C-rates in the window of 3.0 V to4.2 V. Rate capability can be determined through galvanostatic charge-discharged cycling using different C-rates. These tests can began with five cycles at 0.1 C. Next, the C-rate can be increased up to 4 C. Each C-rate can be tested for five consecutive cycles prior to moving to the next C-rate. The last five cycles can be conducted at 0.1 C to determine any changes in capacity due to the testing method.

### EXAMPLE

Example 1 explores using plasma enhanced chemical vapor deposition (PECVD) to polymerize and deposit a conductive polymer coating on a surface.

Poly(3,4-ethylenedioxythiophene) (PEDOT) was polymerized and deposited using PECVD onto a silicon wafer (available from University Wafer in Boston, MA; 1-side polished, 525 μm thick, resistivity 0-100 ohms/cm), a glass wafer (available from MSE Supplies in Tucson, Az; 2-sided polish, 500 μm thick), and a sodium chloride infrared detection card (available from Sigma-Aldrich, Burlington, MA; 19 mm aperture).

Deposition of PEDOT films was accomplished using the Thierry Femto PECVD System (available from Theirry Corporation, Royal Oak, MI). The deposition chamber was cleaned by chemical etching using a mixture of 80% carbon tetrafluoride gas to 20% oxygen gas at a plasma power of 50%. The process gases used were argon (Ar, carrier gas), nitrogen (N₂, carrier gas), helium (carrier gas), and oxygen (O₂, process gas). The 3,4-ethylenedioxythiophene (EDOT; available Thermo Fisher Scientific, Waltham, MA) monomer was introduced into the reaction chamber using a bubbler bottle in which the flow of inert gas volatilizes the monomer forming vapor (the monomer mixture including the PEDOT monomer and a carrier gas). For experiments testing gas-phase oxidative polymerization, oxygen gas was introduced using a separate gas line (e.g., the process gas). All experiments were done with a chamber temperature setpoint of 20° C. Both continuous wave (CW) plasma conditions and pulsed wave (PW) plasma conditions were tested. Table 1 shows PECVD conditions for coatings tested in Example 1.

A commercial analog, HTL Solar 3 PEDOT complex, was purchased from Ossila (Sheffield, England) to provide a comparative conductivity value. A 100 nm film of a commercial PEDOT complex was deposited onto a substrate by spin coating at 1000 rpm.

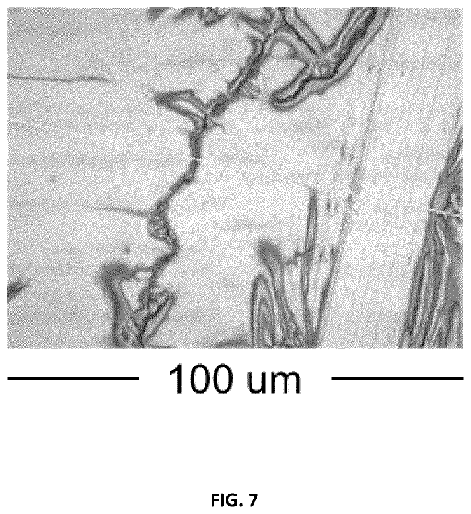

The deposited coatings were assessed using profilometry, optical microscopy, Fourier transform infrared spectroscopy (FTIR), and four-point probe resistivity measurements. It was determined that the carrier gas identity, gas flow rate, plasma power, and duty cycle may all impact the film structure. The deposited films were visualized using optical microscopy. Films deposited using a mixed nitrogen/oxygen atmosphere showed evidence of film cracking (FIG. 7). Conditions able to generate a conductive film with properties similar to that of commercially produced analogs were discovered. A 130 nm film deposited using pulsed plasma with a 1% duty cycle using a 70% oxygen (process gas) and 30% nitrogen gas (carrier gas) atmosphere demonstrated a conductivity of 1.6 S/m. In comparison, the deposited commercial PEDOT complex had a conductivity of 1.3 S/m.

TABLE 1

| | | | | | | | Sheet |
|---|---|---|---|---|---|---|---|
| | Type | RF | Cycle | Pre-plasma | Coating | Thickness | Resistance |
| | of | Power | Duty | mixture | Thickness | St. | (Mega |
| Coating No. | Plasma | (W) | (%) | composition* | (nm) | Dev. | ohm/square) |
| Commercial | NA | — | — | NA | 100 | | 6 |
| PEDOT (Spin | | | | | | | |
| coated) | | | | | | | |
| 1 | CW | 30 | — | 50% Ar:50% 02 | 45.3 | 31.1 | not |
| | | | | | | | measurable |
| 2 | CW | 30 | — | 50% Ar:50% 0₂ | 35.0 | 2.8 | not |
| | | | | | | | measurable |
| 3 | CW | 30 | — | 100% Ar | 142.3 | 1.5 | not |
| | | | | | | | measurable |
| 4 | CW | 30 | — | 100% Ar | 144.3 | 11.2 | not |
| | | | | | | | measurable |
| 5 | CW | 30 | — | 50% Ar:50% 0₂ | 17.2 | 18.4 | not |
| | | | | | | | measurable |
| 6 | CW | 30 | — | 50% Ar:50% 0₂ | 35.7 | 11.0 | not |
| | | | | | | | measurable |
| 7 | CW | 30 | — | 100% Ar | 105.7 | 10.3 | — |
| 8 | CW | 30 | — | 100% Ar | 136.3 | 36.1 | — |
| 9 | CW | 15 | — | 100% Ar | — | — | not |
| | | | | | | | measurable |
| 10 | CW | 15 | — | 80% Ar:20% 0₂ | — | — | not |
| | | | | | | | measurable |
| 11 | CW | 15 | — | 100% Ar, 100% O₂ | — | — | not |
| | | | | | | | measurable |
| 12 | CW | 30 | — | 100% Ar, 33% O₂:66% Ar | — | — | 12 |
| 13 | PW | 15 | 2 | 80% N₂:20% 0₂ | — | — | not |
| | | | | | | | measurable |
| 14 | PW | 6 | 1 | 80% N₂:20% 0₂ | — | — | not |
| | | | | | | | measurable |
| 15 | PW | 6 | 1 | 100% N₂ | — | — | not |
| | | | | | | | measurable |
| 16 | PW | 15 | 0.5 | 80% N₂:20% 0₂ | — | — | not |
| | | | | | | | measurable |
| 17 | PW | 6 | 0.5 | 30% N₂:70% O₂ | — | — | 16 |
| 18 | PW | 6 | 0.5 | 30% N₂:70% O₂ | 39.3 | 11.7 | 16 |
| 19 | PW | 6 | 0.5 | 30% N₂:70% O₂ | — | — | 14 |
| 20 | PW | 6 | 0.5 | 100% N₂ | — | — | not |
| | | | | | | | measurable |
| 21 | CW | 6 | — | 30% N₂:70% O₂ | — | — | not |
| | | | | | | | measurable |
| 22 | CW | 6 | — | 100% N₂ | 165.0 | 69.8 | not |
| | | | | | | | measurable |
| 23 | CW | 15 | — | 100% N₂ | 205.7 | 20.8 | not |
| | | | | | | | measurable |
| 24 | CW | 30 | — | 100% N₂ | 187.7 | 24.7 | not |
| | | | | | | | measurable |
| 25 | CW | 90 | — | 100% N₂ | 154.7 | 67.5 | not |
| | | | | | | | measurable |
| 26 | CW | 15 | — | 70% N₂:30% O₂ | too uneven | | 10 |
| | | | | | to measure | | |
| 27 | CW | 15 | — | 50% N₂:50% O₂ | 45.3 | 13.3 | not |
| | | | | | | | measurable |
| 28 | CW | 15 | — | 30% N₂:70% O₂ | 41.0 | 7.2 | — |
| 29 | CW | 15 | — | 70% N₂:30% O₂ | 33.7 | 4.0 | 9 |
| 30 | CW | 15 | — | 50% N₂:50% O₂ | 37.0 | 13.7 | not |
| | | | | | | | measurable |
| 31 | CW | 15 | — | 30% N₂:70% O₂ | 36.3 | 12.5 | not |
| | | | | | | | measurable |
| 32 | PW | 15 | 2.5 | 70% N₂:30% O₂ | 73.7 | 21.4 | not |
| | | | | | | | measurable |
| 33 | PW | 15 | 1 | 100% N₂ | 50.0 | 16.1 | not |
| | | | | | | | measurable |
| 34 | PW | 15 | 2 | 100% N₂ | 85.0 | 22.1 | not |
| | | | | | | | measurable |
| 35 | PW | 15 | 3 | 100% N₂ | 102.3 | 37.3 | not |
| | | | | | | | measurable |
| 36 | PW | 15 | 4 | 100% N₂ | 67.3 | 10.7 | not |
| | | | | | | | measurable |
| 37 | PW | 15 | 5 | 100% N₂ | 78.3 | 15.9 | not |
| | | | | | | | measurable |
| 38 | PW | 6 | 1 | 30% N₂:70% O₂ | 135.0 | 17.5 | 4 |
| 39 | PW | 6 | 1 | 30% Ar:70% O₂ | — | — | 6 |
| 40 | PW | 6 | 1 | 30% Ar:70% O₂ | 134.7 | 84.7 | 5 |
| 41 | PW | 6 | 1 | 70% Ar:30% O₂ | — | — | not |
| | | | | | | | measurable |
| 42 | PW | 6 | 1 | 70% Ar:30% O₂ | — | — | not |
| | | | | | | | measurable |
| 43 | PW | 6 | 1 | 20% N₂:80% O₂ | — | — | 6 |
| 44 | CW | 6 | — | 30% N₂:70% O₂ | — | — | not |
| | | | | | | | measurable |
| 45 | CW | 15 | — | 30% N₂:70% O₂ | — | — | not |
| | | | | | | | measurable |
| 46 | CW | 30 | — | 30% N₂:70% O₂ | — | — | not |
| | | | | | | | measurable |
| 47 | CW | 45 | — | 30% N₂:70% O₂ | — | — | not |
| | | | | | | | measurable |
| 48 | CW | 90 | — | 30% N₂:70% O₂ | — | — | not |
| | | | | | | | measurable |

CW is continuous wave;
PW is pulsed wave;
*monomer mass not included

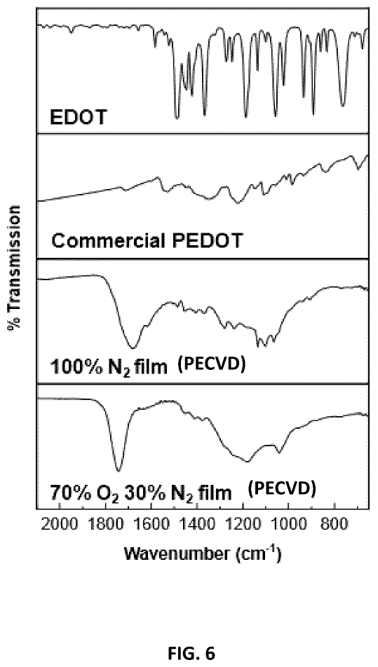

FTIR results indicate that structural difference between the PECVD polymers and the commercial PEDOT polymer (FIG. 6). For example, the N₂ and N₂:O₂ atmosphere samples display is a peak shift at 1678 cm⁻¹ under N₂ conditions to 1734 cm⁻¹ under N₂:O₂ conditions. The same stretch is not observed in the commercial PEDOT sample. This shift suggests that during plasma deposition there is disruption of the oxygen bridge on the thiophene ring.

What is claimed is:

1. A coated electrode active material comprising:
an electrode active material; and
a continuous, conformal coating disposed on a surface of the electrode active material, the coating having a thickness of 100 nm or less as measured via the Thickness Test Method, and the coating comprising:
a plasma polymerized electrically and ionically conductive polymer.

2. The coated electrode active material of claim 1, wherein the plasma polymerized electrically and ionically conductive polymer was polymerized in the presence of plasma formed from a pre-plasma mixture comprising oxygen.

3. The coated electrode active material of claim 1 wherein the coating has an electronic conductivity of 1 S/m or greater as measure according to the Electronic Conductivity Test Method.

4. The coated electrode active material of claim 1, wherein the coating has a thickness of 5 nm or less as measured via the Thickness Test Method.

5. The coated electrode active material of claim 1, wherein the electrically conductive polymer is polymerized from a hydrocarbon monomer comprising an aromatic group; an acyclic hydrocarbon monomer; a heteroaromatic monomer; a heteroaryl monomer; a mixed heteroatom containing monomer; or any combination thereof.

6. The coated electrode active material of claim 5,
wherein:
the hydrocarbon monomer comprising an aromatic group is fluorene, phenylene, pyrene, azulene, naphthalene, or styrene;
the acyclic hydrocarbon monomer is acetylene;
the heteroaromatic monomer is pyrrole, carbazole, indole, azepine, or thiophene;
the heteroaryl monomer is phenol, aniline, or phenyl sulfide; and
the mixed heteroatom containing monomer is 3,4-ethylenedioxythiophene.

7. The coated electrode active material of any of claim 1, wherein the polymer comprises poly(3,4-ethylenedioxythiophene).

8. An electrode assembly comprising:
a current collector; and
an electrode composite comprising:
the coated electrode active material of any claim 1;
an additive; and
a binder.

9. An electrochemical cell comprising:
a positive electrode assembly;
a negative electrode assembly, at least one of the positive electrode assembly and the negative electrode assembly comprising the electrode assembly of claim 8;
a separator; and
an electrolyte.

10. A coated electrode assembly comprising:
an electrode assembly comprising:
a current collector; and
an electrode composite comprising:
an electrode active material;
a binder; and
an additive;
a continuous, conformal coating disposed on a surface of the electrode assembly, the coating having a thickness of 100 nm or less as measured via the Thickness Test Method, and the coating comprising an electrically and ionically conductive polymer, wherein the coating has an electronic conductivity of 1 S/m or greater.

11. The coated electrode assembly of claim 10, wherein the electrically and ionically conductive polymer is a plasma polymerized electrically and ionically conductive polymer.

12. The coated electrode assembly of claim 10, wherein the coating has a thickness of 5 nm or less as measured via the Thickness Test Method.

13. The coated electrode assembly of claim 10, wherein the electrically conductive polymer is polymerized from a hydrocarbon monomer comprising an aromatic group; an acyclic hydrocarbon monomer; a heteroaromatic monomer; a heteroaryl monomer; a mixed heteroatom containing monomer; or any combination thereof.

14. The coated electrode assembly of claim 13,
wherein:
the hydrocarbon monomer comprising an aromatic group is fluorene, phenylene, pyrene, azulene, naphthalene, or styrene;
the acyclic hydrocarbon monomer is acetylene;
the heteroaromatic monomer is pyrrole, carbazole, indole, azepine, or thiophene;
the heteroaryl monomer is phenol, aniline, or phenyl sulfide; and
the mixed heteroatom containing monomer is 3,4-ethylenedioxythiophene.

15. The coated electrode assembly of claim 10, wherein the polymer comprises poly(3,4-ethylenedioxythiophene).

16. An electrochemical cell comprising:
a positive electrode assembly;
a negative electrode assembly, at least one of the positive electrode assembly and the negative electrode assembly comprising the electrode assembly of any of claim 10;
a separator; and
an electrolyte.

17. A coated electrode active material comprising:
an electrode active material;
a continuous, conformal coating disposed on a surface of the electrode active material, the coating having a thickness of 100 nm or less, and the coating comprising:
an electrically and ionically conductive polymer,
wherein the coating has an electronic conductivity of 1 S/m or greater as measured according to the Electronic Conductivity Test Method;
the coated electrode active material formed by a method comprising:
polymerizing and depositing the polymer of the coating onto the electrode active surface using plasma enhanced chemical vapor deposition.

18. The coated electrode active material of claim 17, wherein exposing a pre-plasma mixture to plasma forming conditions comprises exposing the pre-plasma mixture to a continuous electromagnetic field.

19. The coated electrode active material of claim 18, wherein the pre-plasma mixture comprises a monomer and a carrier gas comprising nitrogen gas, argon gas, helium gas, or any combinations thereof.

20. The coated electrode active material of claim 18, wherein the pre-plasma mixture comprises oxygen.
